(19) United States
(12) Patent Application Publication
(10) Pub. No.: US 2023/0378541 A1
(43) Pub. Date: Nov. 23, 2023

(54) RECHARGEABLE BATTERY CELL

(71) Applicant: Innolith Technology AG, Basel (CH)

(72) Inventors: Laurent Zinck, Mothern (FR); Markus Borck, Stuttgart (DE); Julia Thümmel, Bruchsal-Untergrombach (DE)

(21) Appl. No.: 18/361,595

(22) Filed: Jul. 28, 2023

Related U.S. Application Data
(63) Continuation of application No. PCT/EP2022/051762, filed on Jan. 26, 2022.

(30) Foreign Application Priority Data
Jan. 29, 2021 (EP) 21 154 259.2

(51) Int. Cl. H01M 10/0568; H01M 4/62; H01M 10/0567; H01M 10/0525

(52) U.S. Cl. CPC H01M 10/0568; H01M 4/623; H01M 10/0567; H01M 10/0525

(57) ABSTRACT

This disclosure relates to rechargeable battery cells containing an active metal, at least one positive electrode having a planar discharge element, at least one negative electrode having a planar discharge element, a housing and an SO₂-based electrolyte containing a first conductive salt, wherein the positive and/or the negative electrode contains at least one first binder consisting of a polymer based on monomeric styrene and butadiene structural units, and at least one second binder from the group consisting of carboxymethyl celluloses.

### RELATED APPLICATIONS

This application is a continuation of PCT/EP2022/051762, filed Jan. 26, 2022, which claims priority to EP 21 154 259.2, filed Jan. 29, 2021, the entire disclosures of both of which are hereby incorporated herein by reference.

### BACKGROUND

This disclosure relates to a rechargeable battery cell having an SO₂-based electrolyte.

Rechargeable battery cells are of great importance in many technical fields. They are often used for applications that only require small, rechargeable battery cells with relatively low current levels, such as when operating mobile phones. In addition, however, there is also a great need for larger, rechargeable battery cells for high-energy applications, with mass storage of energy in the form of battery cells for electrically driven vehicles being of particular importance.

An important requirement for such rechargeable battery cells is a high energy density. This means that the rechargeable battery cell should contain as much electrical energy as possible per unit of weight and volume. Lithium has proven to be particularly advantageous as the active metal for this purpose. The active metal of a rechargeable battery cell is the metal whose ions within the electrolyte migrate to the negative or positive electrode when charging or discharging the cell and take part in electrochemical processes there. These electrochemical processes lead directly or indirectly to the release of electrons to the external circuit or to the uptake of electrons from the external circuit.

Rechargeable battery cells that contain lithium as the active metal are also referred to as lithium-ion cells. The energy density of these lithium-ion cells can be increased either by increasing the specific capacity of the electrodes or by increasing the cell voltage.

Both the positive and the negative electrode of lithium-ion cells are designed as insertion electrodes. The term “insertion electrode” within the meaning of this disclosure is understood as meaning electrodes which have a crystal structure into which ions of the active material can be intercalated and deintercalated during operation of the lithium-ion cell. This means that the electrode processes can take place not only on the surface of the electrodes, but also within the crystal structure. When charging the lithium-ion cell, the ions of the active metal are deintercalated from the positive electrode and intercalated into the negative electrode. The reverse process occurs when the lithium-ion cell is discharged.

The electrolyte is also an important functional element of every rechargeable battery cell. It usually contains a solvent or a mixture of solvents and at least one conductive salt. Solid electrolytes or ionic liquids, for example, do not contain any solvent, only the conductive salt. The electrolyte is in contact with the positive and negative electrodes of the battery cell. At least one ion of the conductive salt (anion or cation) is mobile in the electrolyte in such a way that ion conduction allows a charge transport to occur between the electrodes, which is necessary for the function of the rechargeable battery cell. Above a certain upper cell voltage of the rechargeable battery cell, the electrolyte is electrochemically decomposed by oxidation. This process often leads to irreversible destruction of components of the electrolyte and thus to failure of the rechargeable battery cell. Reductive processes can also decompose the electrolyte above a certain lower cell voltage. In order to avoid these processes, the positive and negative electrodes are selected in such a way that the cell voltage is below or above the decomposition voltage of the electrolyte. The electrolyte thus determines the voltage window in which a rechargeable battery cell can be operated reversibly, i.e., repeatedly charged and discharged.

The lithium-ion cells known from the prior art contain an electrolyte which consists of an organic solvent or solvent mixture and a conductive salt dissolved therein. The conductive salt is a lithium salt such as lithium hexafluorophosphate (LiPF₆). The solvent mixture can contain ethylene carbonate, for example. Electrolyte LP57, which has the composition 1M LiPF₆ in EC:EMC 3:7, is an example of such an electrolyte. Because of the organic solvent or solvent mixture, such lithium-ion cells are also referred to as organic lithium-ion cells.

In addition to the lithium hexafluorophosphate (LiPF₆) frequently used as a conductive salt in the prior art, other conductive salts for organic lithium-ion cells are also described. For example, the document JP 4 306858 B2 (hereinafter referred to as [V1]) describes conductive salts in the form of tetraalkoxy or tetraaryloxyborate salts, which can be fluorinated or partially fluorinated. JP 2001 143750 A (referred to below as [V2]) reports on fluorinated or partially fluorinated tetraalkoxyborate salts and tetraalkoxyaluminate salts as conductive salts. In both documents [V1] and [V2], the conductive salts described are dissolved in organic solvents or solvent mixtures and used in organic lithium-ion cells.

It has long been known that accidental overcharging of organic lithium-ion cells leads to irreversible decomposition of electrolyte components. In this case, the oxidative decomposition of the organic solvent and/or the conductive salt takes place on the surface of the positive electrode. The heat of reaction generated during this decomposition and the resulting gaseous products are responsible for the subsequent so-called “thermal runaway” and the resulting destruction of the organic lithium-ion cell. The vast majority of charging protocols for these organic lithium-ion cells use cell voltage as an indicator of end-of-charge. Thermal runaway accidents are particularly likely when using multi-cell battery packs, in which several organic lithium-ion cells with mismatched capacities are connected in series.

Therefore, organic lithium-ion cells are problematic in terms of their stability and long-term operational reliability. Safety risks are also caused in particular by the flammability of the organic solvent or solvent mixture. If an organic lithium-ion cell catches fire or even explodes, the organic solvent in the electrolyte forms a combustible material. In order to avoid such safety risks, additional measures must be taken. These measures include, in particular, very precise control of the charging and discharging processes of the organic lithium-ion cell and an optimized battery design. Furthermore, the organic lithium-ion cell contains components that melt when the temperature is unintentionally increased and that can flood the organic lithium-ion cell with molten plastic. This avoids a further uncontrolled increase in temperature. However, these measures lead to increased production costs in the production of the organic lithium-ion cell and to an increased volume and weight. Furthermore, these measures reduce the energy density of the organic lithium-ion cell.

A further development known from the prior art provides for the use of an electrolyte based on sulfur dioxide (SO₂) instead of an organic electrolyte for rechargeable battery cells. Rechargeable battery cells which contain an SO₂-based electrolyte have, among other things, a high ionic conductivity. In the context of this disclosure, the term “SO₂-based electrolyte” is to be understood as meaning an electrolyte that not only contains SO₂ as an additive at a low concentration, but in which the mobility of the ions of the conductive salt contained in the electrolyte, the salt effecting the charge transport, is at least partially, largely or even fully ensured by SO₂. The SO₂ thus serves as a solvent for the conductive salt. The conductive salt can form a liquid solvate complex with the gaseous SO₂, with the SO₂ being bound and the vapor pressure being noticeably reduced compared to pure SO₂. This results in electrolytes with a low vapor pressure. Such electrolytes based on SO₂ have the advantage of non-combustibility compared to the organic electrolytes described above. Safety risks which are due to the flammability of the electrolyte can be ruled out this way.

The choice of a binder for the positive and negative electrodes is important for both lithium-ion cells having an organic electrolyte solution and for rechargeable battery cells having an SO₂-based electrolyte. Binders are intended to improve the mechanical and chemical stability of the electrodes. The formation of cover layers on the negative electrode, and thus the cover layer capacity in the first cycle, should be as low as possible and the service life of the battery cell should be increased. This binder must be stable with respect to the electrolyte used, maintaining its stability over a long period of time even if during the course of the charging and discharging cycles, in the event of possible malfunctions, the active metal, i.e., lithium in the case of a lithium cell, is metallically deposited and comes into contact with the binder. If the binder reacts with the metal, the result is a destabilization of the mechanical structure of the electrode. Binders in the electrode affect the wettability of the electrode surface. If the wettability is impaired, this results in high resistances within the rechargeable battery cell. Problems with the operation of the rechargeable battery cell are the result. An important aspect when choosing the binder is the shape of the discharge element. Discharge elements can be planar, for example, in the form of a thin metal sheet or a thin metal foil, or three-dimensional in the form of a porous metal structure, e.g., in the form of a metal foam. A three-dimensional porous metal structure is porous enough for the active material of the electrode to be incorporated into the pores of the metal structure. In the case of the planar discharge element, the active material is applied to the surface of the front and/or the rear of the planar discharge element. Depending on the shape of the discharge element, there are different requirements for the binder, for example, adhesion to the discharge element must be sufficient. When choosing the binder and its mass fraction within the electrode, a compromise often has to be found between mechanical stabilization on the one hand and improvement of the electrochemical properties of the electrode on the other.

For example, the authors of the following article (hereinafter referred to as [V3]) report:
“Effects of Styrene-Butadiene Rubber/Carboxymethylcellulose (SBR/CMC) and Polyvinylidene Difluoride (PVDF) Binders on Low Temperature Lithium Ion Batteries” Jui-Pin Yen, Chia-Chin Chang, Yu-Run Lin, Sen-Thann Shen and Jin-Long Honga Journal of The Electrochemical Society, 160 (10) A1811-A1818 (2013)
   on investigations of graphite-based anodes having the binders SBR/CMC or PVDF in an organic electrolyte solution with LiPF₆ as conductive salt (1M) in ethylene carbonate (EC)/diethyl carbonate (DEC) (v/v=1:1). They come to the conclusion that the electrodes with the PVDF binder have a lower resistance, a better discharge rate and better cycle stability compared to the electrodes with the SBR/CMC binder mixture.

U.S. Publication No. 2015/0093632 A1 (hereinafter referred to as [V4]) discloses an SO₂-based electrolyte having the composition LiAlCl₄*SO₂. The electrolyte preferably contains a lithium tetrahalogenoaluminate, particularly preferably a lithium tetrachloroaluminate (LiAlCl₄), as the conductive salt. The positive and negative electrodes are unusually thick and comprise a discharge element having a three-dimensional porous metal structure. In order to increase the starting capacity and to improve the mechanical and chemical stability of the negative and positive electrodes, it is proposed to use a binder A which consists of a polymer composed of monomeric structural units of a conjugated carboxylic acid or of the alkali, alkaline earth metal or ammonium salt of this conjugated carboxylic acid, or a combination thereof, such as lithium polyacrylate (LiPAA), or a binder B which consists of a polymer based on monomeric styrene and butadiene structural units or a mixture of binders A and B.

WO 2020/221564 (hereinafter referred to as [V5]) also discloses an SO₂-based electrolyte having, inter alia, LiAlCl₄ as a conductive salt in combination with a sulfur-doped positive electrode active material. Proposed binders for the negative electrode and for the positive electrode, which preferably have a discharge element with a three-dimensional porous metal structure, include fluorinated binders, e.g., vinylidene fluoride (THV) or polyvinylidene fluoride (PVDF), or salts of polyacrylic acid, e.g., lithium polyacrylate (LiPAA) or binders from a polymer based on monomeric styrene and butadiene structural units, or binders from the group of carboxymethylcelluloses. Polymers made from an alkali salt of a conjugated carboxylic acid have proven particularly useful for the negative electrode. THV and PVDF in particular have proven themselves for the positive electrode.

A disadvantage that also occurs with these SO₂-based electrolytes, among other things, is that any hydrolysis products formed in the presence of residual amounts of water react with the cell components of the rechargeable battery cell and thus lead to the formation of undesirable by-products. Because of this, when manufacturing such rechargeable battery cells with an SO₂-based electrolyte, care must be taken to minimize the residual water content in the electrolyte and the cell components.

Another problem with SO₂-based electrolytes is that many conductive salts, especially those known for organic lithium-ion cells, are not soluble in SO₂.

TABLE 1
Solubilities of Various Conductive Salts in SO₂

| | Solubility/ | | Solubility/ |
|---|---|---|---|
| Conductive Salt | mol/L in SO₂ | Conductive Salt | mol/L in SO₂ |
| LiF | 2.1 · 10⁻³ | LiPF₆ | 1.5 · 10⁻² |
| LiBr | 4.9 · 10⁻³ | LiSbF₆ | 2.8 · 10⁻⁴ |
| Li₂SO₄ | 2.7 · 10⁻⁴ | LiBF₂(C₂O₄) | 1.4 · 10⁻⁴ |
| LiB(C₂O₄)₂ | 3.2 · 10⁻⁴ | CF₃SO₂NLiSO₂CF₃ | 1.5 · 10⁻² |
| Li₃PO₄ | — | LiBO₂ | 2.6 · 10⁻⁴ |
| Li₃AlF₆ | 2.3 · 10⁻³ | LiAlO₂ | 4.3 · 10⁻⁴ |
| LiBF₄ | 1.7 · 10⁻³ | LiCF₃SO₃ | 6.3 · 10⁻⁴ |
| LiAsF₆ | 1.4 · 10⁻³ | | |

Measurements showed that SO₂ is a poor solvent for many conductive salts, such as lithium fluoride (LiF), lithium bromide (LiBr), lithium sulfate (Li₂SO₄), lithium bis(oxalato)borate (LiBOB), lithium hexafluoroarsenate (LiAsF₆), lithium tetrafluoroborate (LiBF₄), trilithium hexafluoroaluminate (Li₃AlF₆), lithium hexafluoroantimonate (LiSbF₆), lithium difluoro(oxalato)borate (LiBF₂C₂O₄), lithium bis(trifluoromethanesulfonyl)imide (LiTFSI), lithium metaborate (LiBO₂), lithium aluminate (LiAlO₂), lithium triflate (LiCF₃SO₃), and lithium chlorosulfonate (LiSO₃Cl). The solubility of these conductive salts in SO₂ is approx. 10⁻²-10⁻⁴ mol/L (see Table 1). At these low salt concentrations, it can be assumed that there are only ever low conductivities in effect which are not sufficient for operating a rechargeable battery cell in a reasonable manner.

### SUMMARY

In order to further improve the possible uses and properties of rechargeable battery cells that contain an SO₂-based electrolyte, this disclosure teaches a rechargeable battery cell having SO₂-based electrolytes, the battery cell, compared to the rechargeable battery cells known from the prior art,
comprises electrodes with inert binders, the binders not exhibiting any reactions with the SO₂-based electrolyte, being stable even at higher charging potentials, not accelerating any oxidative decomposition of the electrolyte and not impairing the reactions forming the cover layer;
comprises a binder for producing electrodes having good mechanical stability;
comprises a binder that can be distributed or applied uniformly, together with an active material of the electrodes, on the discharge element of the respective electrode and that enables a good electrical connection of the active material to the discharge element of the respective electrode;
has good wettability of the electrodes with the electrolyte;
has the lowest possible price and high availability, especially for large batteries or for batteries with a wide distribution;
has a wide electrochemical window so that oxidative electrolyte decomposition does not occur at the positive electrode;
has a stable cover layer on the negative electrode, wherein the cover layer capacity should be low and no further reductive electrolyte decomposition should occur on the negative electrode during further operation;
contains an SO₂-based electrolyte which has good solubility for conductive salts, and is therefore a good ionic conductor and electronic insulator so that ionic transport can be facilitated and self-discharge can be kept to a minimum;
contains an SO₂-based electrolyte that is also inert to other rechargeable battery cell components such as separators, electrode materials and cell packaging materials;
is robust against various abuses such as electrical, mechanical or thermal;
has improved electrical performance data, in particular a high energy density;
has an improved overcharge capability and deep discharge capability and a lower self-discharge and
exhibits an increased service life, in particular a high number of serviceable charging and discharging cycles.

Such rechargeable battery cells should in particular also have very good electrical energy and performance data, high operational reliability and service life, in particular a large number of serviceable charging and discharging cycles, without the electrolyte decomposing during operation of the rechargeable battery cell.

A rechargeable battery cell according to this disclosure comprises an active metal, at least one positive electrode having a planar discharge element, at least one negative electrode having a planar discharge element, a housing and an SO₂-based electrolyte containing a first conductive salt. The positive and/or the negative electrodes contain at least one first binder and at least one second binder. The first binder consists of a polymer based on monomeric styrene and butadiene structural units. The second binder is selected from the group consisting of carboxymethyl celluloses.

During the development of this battery cell according to this disclosure, the applicant faced a number of difficult problems associated with the use of the SO₂-based electrolyte and the use of planar discharge elements. In order to distribute the active material together with the respective binder or combination of binders as evenly as possible on the planar discharge element, it must be possible to produce a homogeneous mixture of the components together with a solvent. This homogeneous mixture must be easy to apply to the planar discharge element. If these conditions are not met, considerable problems arise in the production of a mechanically stable electrode. In the case of the rechargeable battery cell according to this disclosure, these problems were solved because a homogeneous mixture could be produced from the first and the second binder together with the active material, and because this homogeneous mixture could be easily applied to the planar discharge element of the respective electrode. In particular, styrene-butadiene rubber can be used as the first binder (SBR). In the case of the second binder, carboxymethyl cellulose (abbr.: CMC) is used.

In the context of this disclosure, the term “discharge element” refers to an electronically conductive element which serves to enable the required electronically conductive connection of the active material of the respective electrode to the external circuit. For this purpose, the discharge element is in electronic contact with the active material involved in the electrode reaction of the electrode. The discharge element is planar, that is to say it exists as an approximately two-dimensional embodiment.

The SO₂-based electrolyte used in the rechargeable battery cell according to this disclosure contains SO₂ not only as an additive at a low concentration, but also at concentrations at which the mobility of the ions of the first conductive salt, which is contained in the electrolyte and effects the charge transport, is at least partially, largely or even fully ensured by the SO₂. The first conductive salt is dissolved in the electrolyte and exhibits very good solubility therein. It can form a liquid solvate complex with the gaseous SO₂, the SO₂ being bound in said complex. In this case, the vapor pressure of the liquid solvate complex drops significantly compared to pure SO₂, forming electrolytes with a low vapor pressure. However, it is also within the scope of this disclosure that no reduction in vapor pressure can occur during the production of the electrolyte according to this disclosure regardless of the chemical structure of the first conductive salt. In the latter case, it is preferred that the electrolyte according to this disclosure is produced at low temperature or under pressure. The electrolyte can also contain a plurality of conductive salts which differ from one another in their chemical structure.

A rechargeable battery cell having such an electrolyte has the advantage that the first conductive salt contained therein has a high oxidation stability, and consequently shows essentially no decomposition at higher cell voltages. This electrolyte is stable against oxidation, preferably at least up to an upper potential of 4.0 volts, more preferably at least up to an upper potential of 4.2 volts, more preferably at least up to an upper potential of 4.4 volts, more preferably at least up to an upper potential of 4.6 volts, more preferably at least to an upper potential of 4.8 volts and particularly preferably at least to an upper potential of 5.0 volts. Thus, when such an electrolyte is used in a rechargeable battery cell, there is little or no electrolyte decomposition within the working potentials, i.e., in the range between the end-of-charge voltage and the end-of-discharge voltage of both electrodes of the rechargeable battery cell. This allows rechargeable battery cells according to this disclosure to have an end-of-charge voltage of at least 4.0 volts, more preferably at least 4.4 volts, more preferably at least 4.8 volts, more preferably at least 5.2 volts, more preferably at least 5.6 volts and particularly preferably of at least 6.0 volts. The service life of the rechargeable battery cell containing this electrolyte is significantly longer than rechargeable battery cells containing electrolytes known from the prior art.

Furthermore, a rechargeable battery cell having such an electrolyte is also resistant to low temperatures. For example, at a temperature of −40° C., 61% of the charged capacity can still be discharged. The conductivity of the electrolyte at low temperatures is sufficient to operate a battery cell.

### Positive Electrode

Advantageous developments of the rechargeable battery cell according to this disclosure with regard to the positive electrode are described below:

A first advantageous development of the rechargeable battery cell according to this disclosure provides that the positive electrode can be charged at least up to an upper potential of 4.0 volts, preferably up to a potential of 4.4 volts, more preferably at least up to a potential of 4.8 volts, more preferably at least up to a potential of 5.2 volts, more preferably at least up to a potential of 5.6 volts and particularly preferably at least up to a potential of 6.0 volts.

In a further advantageous development of the rechargeable battery cell according to this disclosure, the positive electrode contains at least one active material. This material can store ions of the active metal and release and re-absorb the ions of the active metal during operation of the battery cell. It is essential here that good electrical connection of the active material to the planar discharge element is not impaired by the binder of the positive electrode. Through the use of the first and second binder, a good electrical connection of the active material to the planar discharge element of the positive electrode is achieved, the connection also being maintained during operation within a battery.

In a further advantageous development of the rechargeable battery cell according to this disclosure, the positive electrode contains at least one intercalation compound. In the context of this disclosure, the term “intercalation compound” is to be understood as meaning a subcategory of the insertion materials described above. This intercalation compound acts as a host matrix that has interconnected vacancies. The ions of the active metal can diffuse into these vacancies during the discharge process of the rechargeable battery cell and can be intercalated there. Little or no structural changes occur in the host matrix as a result of this intercalation of the active metal ions.

In a further advantageous development of the rechargeable battery cell according to this disclosure, the positive electrode contains at least one conversion compound as an active material. As used herein, the term “conversion compounds” means materials that form other materials during electrochemical activity; i.e., during the charging and discharging of the battery cell, chemical bonds are broken and re-formed. Structural changes occur in the matrix of the conversion compound during the uptake or release of the active metal ions.

In a further advantageous development of the rechargeable battery cell according to this disclosure, the active material has the composition AₓM′_{y}M″_{z}Oₐ. In this composition AₓM′_{y}M″_{z}Oₐ,
A is/are at least one metal selected from the group consisting of the alkali metals, the alkaline earth metals, the metals of group 12 of the periodic table, or aluminum,
M′ is/are at least one metal selected from the group consisting of the elements Ti, V, Cr, Mn, Fe, Co, Ni, Cu and Zn;
M″ is/are at least one element selected from the group consisting of the elements of groups 2, 3, 4, 5, 6, 7, 8, 9, 10, 11, 12, 13, 14, 15 and 16 the periodic table of the elements;
x and y are, independently of one another, numbers greater than 0;
z is a number greater than or equal to 0; and
a is a number greater than 0.

A is preferably the metal lithium, i.e., the compound may have the composition LiₓM′_{y}M″_{z}Oₐ.

The indices y and z in the composition AₓM′_{y}M″_{z}Oₐ refer to all of the metals and elements represented by M′ or M″. For example, if M′ comprises two metals M′¹ and M′², then for the index y, the following applies: y=y1+y2, where y1 and y2 represent the indices of the metals M′¹ and M′². The indices x, y, z and a must be chosen in such a way that there is charge neutrality within the composition. Examples of compounds in which M′ comprises two metals are lithium nickel manganese cobalt oxides of the composition LiₓNi_{y1}Mn_{y2}Co_{z}O₂ where M′¹=Ni, M′²=Mn and M″=Co. Examples of compounds in which z=0, that is to say which have no further metal or element M″, are lithium cobalt oxides LiₓCo_{y}Oₐ. For example, if M″ comprises two elements, on the one hand a metal M″¹ and on the other hand phosphorus as M″², then for the index z, the following applies: z=z1+z2, where z1 and z2 are the indices of the metal M″¹ and of phosphorus (M″²). The indices x, y, z and a must be chosen in such a way that there is charge neutrality within the composition. Examples of compounds in which A includes lithium, M″ includes a metal M″¹ and phosphorus as M″² are lithium iron manganese phosphates LiₓFe_{y}Mn_{z1}P_{z2}O₄ where A=Li, M′=Fe, M″¹=Mn and M″²=P, and z2=1. In another composition, M″ may comprise two non-metals, for example, fluorine as M″¹ and sulfur as M″². Examples of such compounds are lithium iron fluorosulfates Fe_{y}F_{z1}S_{z2}O₄ with A=Li, M′=Fe, M″₁=F and M″₂=P.

A further advantageous development of the rechargeable battery cell according to this disclosure provides that M′ consists of the metals nickel and manganese and M″ is cobalt. This can include compositions of the formula LiₓNi_{y1}Mn_{y2}Co_{z}O₂ (NMC), i.e., lithium nickel manganese cobalt oxides which have the structure of layered oxides. Examples of these lithium nickel manganese cobalt oxide active materials are LiNi_{1/3}Mn_{1/3}Co_{1/3}O₂ (NMC111), LiNi_{0.6}Mn_{0.2}Co_{0.202} (NMC622) and LiNi_{0.8}Mn_{0.1}Co_{0.1}O₂ (NMC811). Other compounds of lithium nickel manganese cobalt oxide can have the composition LiNi_{0.5}Mn_{0.3}Co_{0.2}O₂, LiNi_{0.5}Mn_{0.25}Co_{0.25}O₂, LiNi_{0.52}Mn_{0.32}Co_{0.16}O₂, LiNi_{0.55}Mn_{0.30}Co_{0.15}O₂, LiNi_{0.58}Mn_{0.14}Co_{0.28}O₂, LiNi_{0.64}Mn_{0.18}Co_{0.18}O₂, LiNi_{0.65}Mn_{0.27}Co_{0.08}O₂, LiNi_{0.7}Mn_{0.2}Co_{0.1}O₂, LiNi_{0.7}Mn_{0.15}Co_{0.15}O₂, LiNi_{0.72}Mn_{0.10}Co_{0.18}O₂, LiNi_{0.76}Mn_{0.14}Co_{0.10}O₂, LiNi_{0.86}Mn_{0.04}Co_{0.10}O₂, LiNi_{0.90}Mn_{0.05}Co_{0.05}O₂, LiNi_{0.95}Mn_{0.025}Co_{0.025}O₂ or a combination thereof. With these compounds, positive electrodes for rechargeable battery cells having a cell voltage of over 4.6 volts can be produced.

A further advantageous development of the rechargeable battery cell according to this disclosure provides that the active material is a metal oxide which is rich in lithium and manganese (in English: lithium- and manganese-rich oxide material). This metal oxide can have the composition LiₓMn_{y}M″_{z}Oₐ. M′ thus represents the metal manganese (Mn) in the formula LiₓM′_{y}M″_{z}Oₐ described above. The index x is greater than or equal to 1 here; the index y is greater than the index z or greater than the sum of the indices z1+z2+z3, etc. For example, if M″ includes two metals M″¹ and M″² having the indices z1 and z2 (for example, Li_{1.2}Mn_{0.525}Ni_{0.175}Co_{0.1}O₂, where M″¹=Ni z1=0.175 and M″²=Co z2=0.1) then for the index y, the following applies: y>z1+z2. The index z is greater than or equal to 0 and the index a is greater than 0. The indices x, y, z and a must be chosen in such a way that there is charge neutrality within the composition. Metal oxides rich in lithium and manganese can also be described by the formula mLi₂MnO₃·(1-m)LiM′O₂, where 0<m<1. Examples of such compounds are Li_{1.2}Mn_{0.525}Ni_{0.175}Co_{0.1}O₂, Li_{1.2}Mn_{0.6}Ni_{0.2}O₂ or Li_{1.2}Ni_{0.13}Co_{0.13}Mn_{0.54}O₂.

A further advantageous development of the rechargeable battery cell according to this disclosure provides that the composition has the formula AₓM′_{y}M″_{z}O₄. These compounds are spinel structures. For example, A can be lithium, M′ can be cobalt, and M″ can be manganese. In this case, the active material is lithium cobalt manganese oxide (LiCoMnO₄). LiCoMnO₄ can be used to produce positive electrodes for rechargeable battery cells having a cell voltage of over 4.6 volts. This LiCoMnO₄ is preferably Mn³⁺-free. In another example, M′ may be nickel and M″ may be manganese. In this case, the active material is lithium nickel manganese oxide (LiNiMnO₄). The molar proportions of the two metals M′ and M″ may vary. For example, lithium nickel manganese oxide may have the composition LiNi_{0.5}Mn_{1.5}O₄.

In a further advantageous development of the rechargeable battery cell according to this disclosure, the positive electrode contains, as the active material, at least one active material representing a conversion compound. Conversion compounds undergo a solid-state redox reaction during the uptake of the active metal, for example, lithium or sodium, the crystal structure of the material changing during the reaction. This occurs while chemical bonds are breaking and recombining. Completely reversible reactions of conversion compounds may include the following, for example:
Type A: MX_{z} ↔+y Li M+z Li_{(y/z)}X
Type B: X↔+y Li Li_{y}X

Examples of conversion compounds are FeF₂, FeF₃, CoF₂, CuF₂, NiF₂, BiF₃, FeCl₃, FeCl₂, CoCl₂, NiCl₂, CuCl₂, AgCl, LiCl, S, Li₂S, Se, Li₂Se, Te, I and LiI.

In a further advantageous development, the compound has the composition AₓM′_{y}M″_{z1}M″_{z2}O₄, where M″ is phosphorus and z2 has the value 1. The compound with the composition LiₓM′_{y}M″_{z1}M″_{z2}O₄ is a so-called lithium metal phosphate. In particular, this compound has the composition LiₓFe_{y}Mn_{z1}P_{z2}O₄. Examples of lithium metal phosphates are lithium iron phosphate (LiFePO₄) or lithium iron manganese phosphates (Li(Fe_{y}Mn_{z})PO₄). An example of a lithium iron manganese phosphate is the phosphate of the composition Li(Fe_{0.3}Mn_{0.7})PO₄. An example of a lithium iron manganese phosphate is the phosphate of the composition Li(Fe_{0.3}Mn_{0.7})PO₄. Lithium metal phosphates of other compositions can also be used for the battery cell according to this disclosure.

A further advantageous development of the rechargeable battery cell according to this disclosure provides that the positive electrode contains at least one metal compound. This metal compound is selected from the group consisting of a metal oxide, a metal halide and a metal phosphate. The metal of this metal compound is preferably a transition metal with atomic numbers 22 to 28 in the periodic table of the elements, in particular cobalt, nickel, manganese or iron.

A further advantageous development of the rechargeable battery cell according to this disclosure provides that the positive electrode contains at least one metal compound which has the chemical structure of a spinel, a layered oxide, a conversion compound or a polyanionic compound.

It is within the scope of this disclosure that the positive electrode contains at least one of the described compounds or a combination of the compounds as active material. A combination of the compounds means a positive electrode which contains at least two of the materials described.

The battery cell according to this disclosure comprises a positive electrode with a planar discharge element. This means that the positive electrode also includes a discharge element in addition to the active material. This discharge element serves to facilitate the required electronically conductive connection of the active material of the positive electrode. For this purpose, the discharge element is in contact with the active material involved in the electrode reaction of the positive electrode. This planar discharge element is preferably a thin metal sheet or a thin metal foil. The thin metal foil can have a perforated or net-like structure. The planar discharge element can also consist of a metal-coated plastic film. These metal coatings have a thickness in the range from 0.1 μm to 20 μm. The positive electrode active material is preferably applied to the surface of the thin metal sheet, the thin metal foil or the metal-coated plastic film. The active material can be applied to the front and/or the back of the planar discharge element. Such planar discharge elements have a thickness in the range from 5 μm to 50 μm. A thickness of the planar discharge element in the range from 10 μm to 30 μm is preferred. When using planar discharge elements, the positive electrode can have a total thickness of at least 20 μm, preferably at least 40 μm and particularly preferably at least 60 μm. The maximum thickness is at most 200 μm, preferably at most 150 μm and particularly preferably at most 100 μm. The area-specific capacity of the positive electrode, based on the coating on one side, is preferably at least 0.5 mAh/cm² when using a planar discharge element, with the following values being more preferred in this order: 1 mAh/cm², 3 mAh/cm², 5 mAh/cm², 10 mAh/cm², 15 mAh/cm², 20 mAh/cm². If the discharge element is planar in the form of a thin metal sheet, a thin metal foil or a metal-coated plastic foil, the amount of the active material of the positive electrode, i.e., the loading of the electrode, relative to the coating on one side is preferably at least 1 mg/cm², preferably at least 3 mg/cm², more preferably at least 5 mg/cm², more preferably at least 8 mg/cm², more preferably at least 10 mg/cm², and particularly preferably at least 20 mg/cm².

The maximum loading of the electrode, based on the coating on one side, is preferably at most 150 mg/cm², more preferably at most 100 mg/cm² and particularly preferably at most 80 mg/cm².

In a further advantageous development of the battery cell according to this disclosure, the positive electrode has at least one additional binder that differs from the first and the second binder. This further binder is preferably
a fluorinated binder, in particular a polyvinylidene fluoride (abbr.: PVDF) and/or a terpolymer of tetrafluoroethylene, hexafluoropropylene and vinylidene fluoride, or
a polymer built up from monomeric structural units of a conjugated carboxylic acid or from the alkali, alkaline earth or ammonium salt of this conjugated carboxylic acid or from a combination thereof.

The further binder in polymer form can be lithium polyacrylate (LiPAA). The positive electrode may also contain two other binders other than the first and second binders. In this case, the positive electrode preferably contains a third binder in the form of the fluorinated binder, in particular the polyvinylidene fluoride binder (abbr.: PVDF) and/or the terpolymer of tetrafluoroethylene, hexafluoropropylene and vinylidene fluoride, and a fourth binder in polymer form built up from monomeric structural units of a conjugated carboxylic acid or from the alkali, alkaline earth or ammonium salt of this conjugated carboxylic acid or from a combination thereof. When using the fluorinated binder, there is the problem that these binders often only dissolve in highly flammable, environmentally harmful, organic solvents. In the production of positive electrodes having a fluorinated binder, expensive equipment must be used in order to handle these solvents. Explosion protection, environmental protection and protection of exposed employees are particularly problematic here. The applicant had to take these problems into account when developing this advantageous development of the battery cell according to this disclosure.

During the development of the rechargeable battery cell of the present patent application, the applicant found that the optimal concentration of the first, second, third and/or fourth binder relative to the total weight of the positive electrode is difficult to determine: Too low of a concentration in the positive electrode led to poor handling of the positive electrode produced, since, for example, binder-free electrodes have no adhesion to the discharge element and particles of the active material can be released, the rechargeable battery cell produced becoming unusable as a result. If the concentration of the binder is too high, this in turn has a negative effect on the energy density of the rechargeable battery cell. This is because the energy density is lowered by the weight of the binder. Furthermore, too high of a binder concentration can lead to the positive electrode being poorly wetted by the SO₂-based electrolyte. Because of this, the concentration of all binders in the positive electrode is preferably at most 20 wt %, more preferably at most 15 wt %, more preferably at most 10 wt %, more preferably at most 7 wt %, more preferably at most 5 wt %, more preferably at most 2 wt % %, more preferably at most 1 wt % and particularly preferably at most 0.5 wt % relative to the total weight of the positive electrode. The concentration of all binders in the positive electrode is preferably in the range between 0.05 wt % and 20 wt %, more preferably in the range between 0.5 wt % and 10 wt % and particularly preferably in the range between 0.5 wt % and 5 wt %. The aforementioned concentrations enable good wetting of the positive electrode with the SO₂-based electrolyte, good handling of the positive electrode, and good energy density of the rechargeable battery cell having such a positive electrode.

### Electrolyte

Advantageous developments of the rechargeable battery cell are described below with regard to the SO₂-based electrolyte.

An advantageous development of the rechargeable battery cell according to this disclosure provides that the first conductive salt is selected from the group consisting of
an alkali metal compound, in particular a lithium compound selected from the group consisting of an aluminate, in particular lithium tetrahalogenoaluminate, a halide, an oxalate, a borate, a phosphate, an arsenate and a gallate; and
a conductive salt having the formula (I)

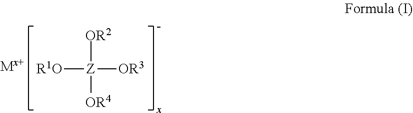

where,
   M is a metal selected from the group consisting of alkali metals, alkaline earth metals, Group 12 metals of the periodic table of elements, and aluminum;
   x is a number from 1 to 3;
   the substituents R¹, R², R³ and R⁴ are independently selected from the group consisting of C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl; and
where Z is aluminum or boron.

For the purposes of this disclosure, the term “C₁-C₁₀ alkyl” includes linear or branched saturated hydrocarbon groups having one to ten carbon atoms. These include, in particular, methyl, ethyl, n-propyl, isopropyl, n-butyl, sec-butyl, isobutyl, tert-butyl, n-pentyl, isopentyl, 2,2-dimethylpropyl, n-hexyl, isohexyl, 2-ethylhexyl, n-heptyl, isoheptyl, n-octyl, isooctyl, n-nonyl, n-decyl and the like.

In the context of this disclosure, the term “C₂-C₁₀ alkenyl” includes unsaturated linear or branched hydrocarbon groups having two to ten carbon atoms, the hydrocarbon groups having at least one C—C double bond. These include in particular ethenyl, 1-propenyl, 2-propenyl, 1-n-butenyl, 2-n-butenyl, isobutenyl, 1-pentenyl, 1-hexenyl, 1-heptenyl, 1-octenyl, 1-nonenyl, 1-decenyl and the like.

In the context of this disclosure, the term “C₂-C₁₀ alkynyl” includes unsaturated linear or branched hydrocarbon groups having two to ten carbon atoms, the hydrocarbon groups having at least one C—C triple bond. These include in particular ethynyl, 1-propynyl, 2-propynyl, 1-n-butynyl, 2-n-butynyl, isobutynyl, 1-pentynyl, 1-hexynyl, 1-heptynyl, 1-octynyl, 1-nonynyl, 1-decynyl and the like.

In the context of this disclosure, the term “C₃-C₁₀ cycloalkyl” includes cyclic, saturated hydrocarbon groups having three to ten carbon atoms. These include, in particular, cyclopropyl, cyclobutyl, cyclopentyl, cyclohexyl, cycloheptyl, cyclohexyl, cyclononyl and cyclodecanyl.

In the context of this disclosure, the term “C₆-C₁₄ aryl” includes aromatic hydrocarbon groups having six to fourteen carbon atoms in the ring. These include in particular phenyl (C₆H₅ group), naphthyl (C₁₀H₇ group) and anthracyl (C₁₄H₉ group).

In the context of this disclosure, the term “C₅-C₁₄ heteroaryl” includes aromatic hydrocarbon groups with five to fourteen ring hydrocarbon atoms in which at least one hydrocarbon atom is replaced or exchanged by a nitrogen, oxygen or sulfur atom. These include in particular pyrrolyl, furanyl, thiophenyl, pyrridinyl, pyranyl, thiopyranyl and the like. All of the aforementioned hydrocarbon groups are bonded to the central atom of the formula (I) via the oxygen atom, respectively.

The lithium tetrahaloaluminate may be lithium tetrachloroaluminate (LiAlCl₄).

In a further advantageous embodiment of the rechargeable battery cells, the substituents R¹, R², R³ and R⁴ of the first conductive salt of the formula (I) are independently selected from the group consisting of
C₁-C₆ alkyl; preferably C₂-C₄ alkyl; particularly preferably the alkyl groups 2-propyl, methyl and ethyl;
C₂-C₆ alkenyl; preferably C₂-C₄ alkenyl; particularly preferably of the alkenyl groups ethenyl and propenyl;
C₂-C₆ alkynyl; preferably C₂-C₄ alkynyl;
C₃-C₆ cycloalkyl;
phenyl; and
C₅-C₇ heteroaryl.

In the case of this advantageous embodiment of the SO₂-based electrolyte, the term “C₁-C₆ alkyl” includes linear or branched saturated hydrocarbon groups having one to six hydrocarbon groups, in particular methyl, ethyl, n-propyl, isopropyl, n-butyl, sec-butyl, isobutyl, tert-butyl, n-pentyl, isopentyl, 2,2-dimethylpropyl, n-hexyl and isohexyl. Among these, preference is given to C₂-C₄ alkyls. The C₂-C₄ alkyls 2-propyl, methyl and ethyl are particularly preferred.

In the case of this advantageous embodiment of the SO₂-based electrolyte, the term “C₂-C₆ alkenyl” includes unsaturated linear or branched hydrocarbon groups having two to six carbon atoms, the hydrocarbon groups having at least one C—C double bond. These include, in particular, ethenyl, 1-propenyl, 2-propenyl, 1-n-butenyl, 2-n-butenyl, isobutenyl, 1-pentenyl and 1-hexenyl, preference being given to C₂-C₄ alkenyls. Ethenyl and 1-propenyl are particularly preferred.

In the case of this advantageous embodiment of the SO₂-based electrolyte, the term “C₂-C₆-alkynyl” includes unsaturated linear or branched hydrocarbon groups having two to six carbon atoms, the hydrocarbon groups having at least one C—C triple bond. These include, in particular, ethynyl, 1-propynyl, 2-propynyl, 1-n-butynyl, 2-n-butynyl, isobutynyl, 1-pentynyl and 1-hexynyl. Preferred among these are C₂-C₄-alkynyls.

In the case of this advantageous embodiment of the SO₂-based electrolyte, the term “C₃-C₆ cycloalkyl” includes cyclic saturated hydrocarbon groups having three to six carbon atoms. These include, in particular, cyclopropyl, cyclobutyl, cyclopentyl and cyclohexyl.

In the case of this advantageous embodiment of the SO₂-based electrolyte, the term “C₅-C₇ heteroaryl” includes phenyl and naphthyl.

In order to improve the solubility of the first conductive salt in the SO₂-based electrolyte, in a further advantageous embodiment of the rechargeable battery cell the substituents R¹, R², R³ and R⁴ are substituted by at least one fluorine atom and/or by at least one chemical group, where the chemical group is selected from the group consisting of C₁-C₄ alkyl, C₂-C₄ alkenyl, C₂-C₄ alkynyl, phenyl and benzyl. The chemical groups C₁-C₄-alkyl, C₂-C₄-alkenyl, C₂-C₄-alkynyl, phenyl and benzyl have the same properties or chemical structures as the hydrocarbon groups described above. In this context, substituted means that individual atoms or groups of atoms of the substituents R¹, R², R³ and R⁴ are replaced by the fluorine atom and/or by the chemical group.

A particularly high solubility of the first conductive salt in the SO₂-based electrolyte can be achieved if at least one of the substituents R¹, R², R³ and R⁴ is a CF₃ group or an OSO₂CF₃ group.

In a further advantageous development of the rechargeable battery cell, the first conductive salt according to formula (I) is selected from the group consisting of

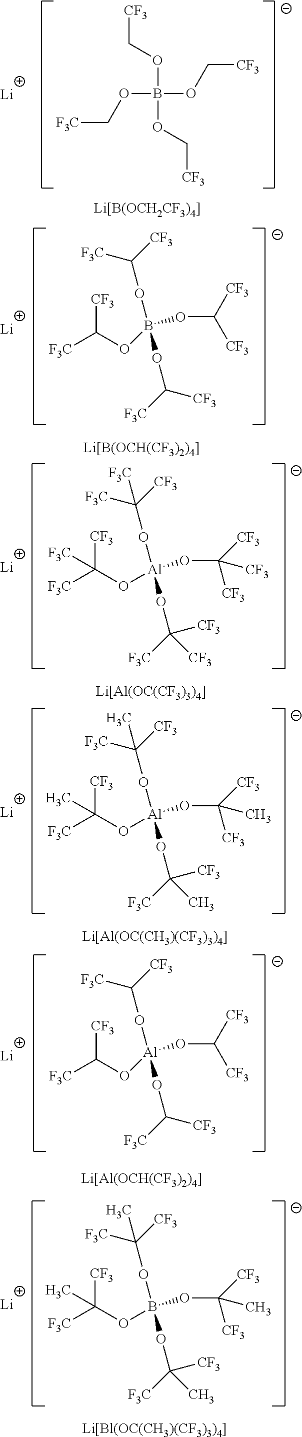

In order to adapt the conductivity and/or other properties of the electrolyte to a desired value, in a further advantageous embodiment of the rechargeable battery cell according to this disclosure the electrolyte comprises at least one second conductive salt which differs from the first conductive salt. This means that, in addition to the first conductive salt, the electrolyte may contain one or even more second conductive salts which differ from the first conductive salt in terms of their chemical composition and their chemical structure.

Furthermore, in a further advantageous embodiment of the rechargeable battery cell according to this disclosure, the electrolyte contains at least one additive. This additive is preferably selected from the group consisting of vinylene carbonate and its derivatives, vinyl ethylene carbonate and its derivatives, methyl ethylene carbonate and its derivatives, lithium (bisoxalato)borate, lithium difluoro(oxalato)borate, lithium tetrafluoro(oxalato)phosphate, lithium oxalate, 2-vinylpyridine, 4-vinylpyridine, cyclic exomethylene carbonates, sultones, cyclic and acyclic sulfonates, acyclic sulfites, cyclic and acyclic sulfinates, organic esters of inorganic acids, acyclic and cyclic alkanes, said acyclic and cyclic alkanes having a boiling point of at least 36° C. at 1 bar, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocyclics.

Based on the total weight of the electrolyte composition, the electrolyte has the following composition in a further advantageous development of the rechargeable battery cell:
(i) 5 to 99.4 wt % sulfur dioxide,
(ii) 0.6 to 95 wt % of the first conductive salt,
(iii) 0 to 25 wt % of the second conductive salt and
(iv) 0 to 10 wt % of the additive.

As already mentioned above, the electrolyte can contain not only a first conductive salt and a second conductive salt, but also a plurality of first and a plurality of second conductive salts. In the latter case, the aforementioned percentages also include a plurality of first conductive salts and a plurality of second conductive salts. The molar concentration of the first conductive salt is in the range from 0.01 mol/l to 10 mol/l, preferably from 0.05 mol/l to 10 mol/l, more preferably from 0.1 mol/l to 6 mol/l and particularly preferably from 0.2 mol/l to 3.5 mol/l relative to the total volume of the electrolyte.

A further advantageous development of the rechargeable battery cell according to this disclosure provides that the electrolyte contains at least 0.1 mole of SO₂, preferably at least 1 mole of SO₂, more preferably at least 5 moles of SO₂, more preferably at least 10 moles of SO₂ and particularly preferably at least 20 moles of SO₂ per mole of conductive salt. The electrolyte can also contain very high molar proportions of SO₂, the preferred upper limit being 2600 moles of SO₂ per mole of conductive salt and upper limits of 1500, 1000, 500 and 100 moles of SO₂ per mole of conductive salt being more preferred, in this order. The term “per mole of conductive salt” refers to all conductive salts contained in the electrolyte. SO₂-based electrolytes having such a concentration ratio between SO₂ and the conductive salt have the advantage that they can dissolve a larger amount of conductive salt compared to the electrolytes known from the prior art which are based, for example, on an organic solvent mixture. Within the scope of this disclosure, it was found that, surprisingly, an electrolyte with a relatively low concentration of conductive salt is advantageous despite the associated higher vapor pressure, in particular with regard to its stability over many charging and discharging cycles of the rechargeable battery cell. The concentration of SO₂ in the electrolyte affects its conductivity. Thus, by choosing the SO₂ concentration, the conductivity of the electrolyte can be adapted to the planned use of a rechargeable battery cell operated with this electrolyte.

The total content of SO₂ and the first conductive salt can be greater than 50 weight percent (wt %) of the weight of the electrolyte, preferably greater than 60 wt %, more preferably greater than 70 wt %, more preferably greater than 80 wt %, more preferably greater than 85 wt %, more preferably greater than 90 wt %, more preferably greater than 95 wt % or more preferably greater than 99 wt %.

The electrolyte can contain at least 5 wt % SO₂ relative to the total amount of the electrolyte contained in the rechargeable battery cell, values of 20 wt % SO₂, 40 wt % SO₂ and 60 wt % SO₂ being more preferred. The electrolyte can also contain up to 95 wt % SO₂, with maximum values of 80 wt % SO₂ and 90 wt % SO₂, in this order, being preferred.

It is within the scope of this disclosure that the electrolyte preferably has only a small percentage or even no percentage of at least one organic solvent. The proportion of organic solvents in the electrolyte present in the form of, for example, one or a mixture of a plurality of solvents, may preferably be at most 50 wt % of the weight of the electrolyte. Lower proportions of at most 40 wt %, at most 30 wt %, at most 20 wt %, at most 15 wt %, at most 10 wt %, at most 5 wt % or at most 1 wt % of the weight of the electrolyte are particularly preferred. More preferably, the electrolyte is free of organic solvents. Due to the low proportion of organic solvents or even their complete absence, the electrolyte is either hardly or not at all flammable. This increases the operational safety of a rechargeable battery cell operated with such an SO₂-based electrolyte. More preferably, the SO₂-based electrolyte is substantially free of organic solvents.

Based on the total weight of the electrolyte composition, the electrolyte has the following composition in a further advantageous development of the rechargeable battery cell:
(i) 5 to 99.4 wt % sulfur dioxide,
(ii) 0.6 to 95 wt % of the first conductive salt,
(iii) 0 to 25 wt % of the second conductive salt,
(iv) 0 to 10 wt % of the additive and
(v) 0 to 50 wt % of an organic solvent.

### Active Metal

Advantageous developments of the rechargeable battery cell according to this disclosure with regard to the active metal are described below:

In one advantageous development, the rechargeable battery cell, the active metal is
an alkali metal, especially lithium or sodium;
an alkaline earth metal, especially calcium;
a metal from group 12 of the periodic table, in particular zinc; or
aluminum.

### Negative Electrode

Advantageous developments of the rechargeable battery cell according to this disclosure with regard to the negative electrode are described below:

A further advantageous development of the rechargeable battery cell provides that the negative electrode is an insertion electrode. This insertion electrode contains an insertion material as an active material into which the active metal ions can be intercalated during the charging of the rechargeable battery cell and from which the active metal ions can be deintercalated during the discharging of the rechargeable battery cell. This means that the electrode processes can take place not only on the surface of the negative electrode, but also inside the negative electrode. If, for example, a lithium-based conductive salt is used, lithium ions can be intercalated into the insertion material during the charging of the rechargeable battery cell and deintercalated from it during the discharging of the rechargeable battery cell. The negative electrode preferably contains carbon as the active material or insertion material, in particular in the graphite modification. However, it is also within the scope of this disclosure for the carbon to be in the form of natural graphite (flake promoter or rounded), synthetic graphite (mesophase graphite), graphitized MesoCarbon MicroBeads (MCMB), carbon-coated graphite, or amorphous carbon.

In a further advantageous development of the rechargeable battery cell according to this disclosure, the negative electrode comprises lithium intercalation anode active materials which do not contain any carbon, for example, lithium titanates (for example, Li₄Ti₅O₁₂).

A further advantageous development of the rechargeable battery cell according to this disclosure provides that the negative electrode comprises active anode materials which form alloys with lithium. These are, for example, lithium-storing metals and metal alloys (e.g., Si, Ge, Sn, SnCoₓC_{y}, SnSiₓ and the like) and oxides of lithium-storing metals and metal alloys (e.g., SnOₓ, SiOₓ, oxidic glasses of Sn, Si and the like).

In a further advantageous development of the rechargeable battery cell according to this disclosure, the negative electrode contains conversion anode active materials. These conversion anode active materials can be, for example, be transition metal oxides in the form of manganese oxides (MnOₓ), iron oxides (FeOₓ), cobalt oxides (CoOₓ), nickel oxides (NiOₓ), copper oxides (CuOₓ) or metal hydrides in the form of magnesium hydride (MgH₂), titanium hydride (TiH₂), aluminum hydride (AlH₃) and boron-, aluminum- and magnesium-based ternary hydrides and the like. It is essential here that a good electrical connection of one of the aforementioned active materials to the planar discharge element is not impaired by the binder of the negative electrode. The use of the first and second binder enables a good electrical connection of the aforementioned active materials to the planar discharge element of the negative electrode, the connection also being maintained during operation within a battery.

In a further advantageous development of the rechargeable battery cell according to this disclosure, the negative electrode comprises a metal, in particular metallic lithium.

A further advantageous development of the rechargeable battery cell according to this disclosure provides that the negative electrode is porous, the porosity preferably being at most 50%, more preferably at most 45%, more preferably at most 40%, more preferably at most 35%, more preferably at most 30%, more preferably at most 20% and particularly preferably at most 10%. The porosity represents the void volume in relation to the total volume of the negative electrode, with the void volume being formed by so-called pores or cavities. This porosity increases the internal surface area of the negative electrode. Furthermore, the porosity reduces the density of the negative electrode and thus its weight. The individual pores of the negative electrode can preferably be completely filled with the electrolyte during operation.

The battery cell according to this disclosure provides that the negative electrode has a planar discharge element. This means that the negative electrode also includes a planar discharge element in addition to the active material or insertion material. This planar discharge element is preferably a thin metal sheet or a thin metal foil. The thin metal foil preferably has a perforated or net-like structure. The planar discharge element can also be a plastic film coated with metal. This metal coating has a thickness in the range from 0.1 μm to 20 μm. The negative electrode active material is preferably coated onto the surface of the thin metal sheet, thin metal foil or metal-coated plastic film. The active material can be applied to the front and/or the back of the planar discharge element. Such planar discharge elements have a thickness in the range from 5 μm to 50 μm. A thickness of the planar discharge element in the range from 10 μm to 30 μm is preferred. When using planar discharge elements, the negative electrode can have a total thickness of at least 20 μm, preferably at least 40 μm and particularly preferably at least 60 μm. The maximum thickness is at most 200 μm, preferably at most 150 μm and particularly preferably at most 100 μm. The area-specific capacity of the negative electrode, relative to the coating on one side, is preferably at least 0.5 mAh/cm² when using a planar discharge element, with the following values being more preferred, in this order: 1 mAh/cm², 3 mAh/cm², 5 mAh/cm², 10 mAh/cm², 15 mAh/cm², 20 mAh/cm². If the discharge element is planar in the form of a thin metal sheet, a thin metal foil or a metal-coated plastic foil, the amount of the active material of the negative electrode, i.e., the loading of the electrode, relative to the coating on one side is preferably at least 1 mg/cm², preferably at least 3 mg/cm², more preferably at least 5 mg/cm², more preferably at least 8 mg/cm², more preferably at least 10 mg/cm², and particularly preferably at least 20 mg/cm². The maximum loading of the electrode, based on the coating on one side, is preferably at most 150 mg/cm², more preferably at most 100 mg/cm² and particularly preferably at most 80 mg/cm².

In a further advantageous development of the battery cell according to this disclosure, the negative electrode comprises at least one further binder that differs from the first and the second binder. This further binder is preferably
a fluorinated binder, in particular a polyvinylidene fluoride (abbr.: PVDF) and/or a terpolymer of tetrafluoroethylene, hexafluoropropylene and vinylidene fluoride, or
a polymer built up from monomeric structural units of a conjugated carboxylic acid or from the alkali, alkaline earth or ammonium salt of this conjugated carboxylic acid or from a combination thereof.

In polymer form, the further binder can be lithium polyacrylate (LiPAA). The negative electrode may also contain two other binders other than the first and second binders. In this case, the negative electrode preferably contains a third binder in the form of the fluorinated binder, in particular polyvinylidene fluoride (abbr.: PVDF) and/or the terpolymer of tetrafluoroethylene, hexafluoropropylene and vinylidene fluoride, and a fourth binder in polymer form built up from monomeric structural units of a conjugated carboxylic acid or from the alkali, alkaline earth or ammonium salt of this conjugated carboxylic acid or from a combination thereof.

When using the fluorinated binder, there is the problem that these often only dissolve in highly flammable, environmentally harmful, organic solvents. In the production of negative electrodes having a fluorinated binder, expensive equipment must be used in order to handle these solvents. Explosion protection, environmental protection and protection of exposed employees are particularly problematic here. The applicant had to take these problems into account when developing this advantageous development of the battery cell according to this disclosure. During the development of the rechargeable battery cell of the present patent application, the applicant found that the optimal concentration of binder relative to the total weight of the negative electrode is difficult to determine: Too low of a concentration in the negative electrode led to poor handling of the negative electrode produced, since, for example, binder-free electrodes have no adhesion to the discharge element and particles of the active material can be released, the rechargeable battery cell produced becoming unusable as a result. If the concentration of the binder is too high, this in turn has a negative effect on the energy density of the rechargeable battery cell. This is because the energy density is lowered by the weight of the binder. Furthermore, too high of a binder concentration can lead to the negative electrodes being poorly wetted by the SO₂-based electrolyte. Because of this, the concentration of all binders in the negative electrode is preferably at most 20 wt %, more preferably at most 15 wt %, more preferably at most 10 wt %, more preferably at most 7 wt %, more preferably at most 5 wt %, more preferably at most 2 wt %, more preferably at most 1 wt % and particularly preferably at most 0.5 wt %, relative to the total weight of the negative electrode. The concentration of all binders in the negative electrode is preferably in the range between 0.05 wt % and 20 wt %, more preferably in the range between 0.5 wt % and 10 wt % and particularly preferably in the range between 0.5 wt % and 5 wt %. The aforementioned concentrations enable good wetting of the negative electrode having the SO₂-based electrolyte, good handling of the negative electrode, and good energy density of a rechargeable battery cell having such a negative electrode. In a further advantageous development of the battery cell according to this disclosure, the negative electrode comprises at least one conductivity additive. The conductivity additive should preferably have a low weight, high chemical resistance and a high specific surface area; examples of conductivity additives are particulate carbon (carbon black, Super P, acetylene black), fibrous carbon (CarbonNanoTtubes CNT, carbon (nano)fibers), finely distributed graphite and graphene (nanosheets).

### Structure of the Rechargeable Battery Cell

Advantageous developments of the rechargeable battery cell according to this disclosure are described below with regard to its structure:

In order to further improve the function of the rechargeable battery cell, a further advantageous development of the rechargeable battery cell according to this disclosure provides that the rechargeable battery cell comprises a plurality of negative electrodes and a plurality of high-voltage electrodes which are stacked alternately in the housing. In this case, the positive electrodes and the negative electrodes are preferably each electrically separated from one another by separators.

However, the rechargeable battery cell can also be designed as a wound cell in which the electrodes consist of thin layers that are wound up together with a separator material. On one hand, the separators separate the positive electrode and the negative electrode spatially and electrically and, on the other hand, they are permeable, inter alia, to the ions of the active metal. In this way, large electrochemically active surfaces are created which enable a correspondingly high current yield.

The separator can be formed from a fleece, a membrane, a woven fabric, a knitted fabric, an organic material, an inorganic material or a combination thereof. Organic separators can consist of unsubstituted polyolefins (for example, polypropylene or polyethylene), partially to fully halogen-substituted polyolefins (for example, partially to fully fluorine-substituted, in particular PVDF, ETFE, PTFE), polyesters, polyamides or polysulfones. Separators containing a combination of organic and inorganic materials are, for example, glass fiber fabrics in which the glass fibers are provided with a suitable polymeric coating. The coating preferably contains a fluorine-containing polymer such as polytetrafluoroethylene (PTFE), ethylene tetrafluoroethylene (ETFE), perfluoroethylene propylene (FEP), THV (terpolymer of tetrafluoroethylene, hexafluoroethylene and vinylidene fluoride), a perfluoroalkoxy polymer (PFA), aminosilane, polypropylene or polyethylene (PE). The separator can also be folded in the housing of the rechargeable battery cell, for example, in the form of a so-called “Z-Folding.” With this Z-Folding, a strip-shaped separator is folded in a Z-like manner through or around the electrodes. Furthermore, the separator can also be designed as separator paper.

It is also within the scope of this disclosure for the separator to be in the form of an enclosure, with each high-voltage electrode or each negative electrode being enclosed by the enclosure. The enclosure can be formed from a fleece, a membrane, a woven fabric, a knitted fabric, an organic material, an inorganic material or a combination thereof.

Enclosing the positive electrode results in more even ion migration and ion distribution in the rechargeable battery cell. The more uniform the ion distribution, in particular in the negative electrode, the higher the possible loading of the negative electrode with active material and consequently the higher the usable capacity of the rechargeable battery cell.

At the same time, risks associated with uneven loading and the resulting deposition of the active metal can be avoided. These advantages have an effect above all when the positive electrodes of the rechargeable battery cell are enclosed by the enclosure.

The surface area dimensions of the electrodes and the enclosure can preferably be matched to one another in such a way that the outer dimensions of the enclosure of the electrodes and the outer dimensions of the non-enclosed electrodes match at least in one dimension.

The surface area extent of the enclosure can preferably be greater than the surface area extent of the electrode. In this case, the enclosure extends beyond a boundary of the electrode. Two layers of the enclosure covering the electrode on both sides may therefore be connected to one another at the edge of the positive electrode by an edge connector.

In a further advantageous embodiment of the rechargeable battery cell according to this disclosure, the negative electrodes have an enclosure, whereas the positive electrodes have no enclosure.

Further advantageous properties of this disclosure are described and explained in more detail below using figures, examples and experiments.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a first exemplary embodiment of a rechargeable battery cell according to this disclosure in a cross-sectional view;

FIG. 2 shows a detail of the first exemplary embodiment from FIG. 1;

FIG. 3 shows a second exemplary embodiment of the rechargeable battery cell according to this disclosure in an exploded view;

FIG. 4 shows a third exemplary embodiment of the rechargeable battery cell according to this disclosure in an exploded view;

FIG. 5 shows the potential in [V] as a function of the capacity, which is related to the theoretical capacity of the negative electrode, during a cover layer formation, of three test full-cells having electrodes comprising different binder combinations and three-dimensional discharge elements and being filled with a lithium tetrachloroaluminate electrolyte from example 1;

FIG. 6 shows the discharge capacity as a function of the number of cycles of three test full-cells having electrodes that have different combinations of binders and three-dimensional discharge elements and that are filled with the lithium tetrachloroaluminate electrolyte from example 1;

FIG. 7 shows the potential in [V] as a function of the capacity of three half-cells having electrodes which have different binder combinations and planar discharge elements and which are filled with the electrolyte 1 from example 1;

FIG. 8 shows the discharge capacity as a function of the number of cycles of two half-cells having electrodes which have different binder combinations and planar discharge elements and which are filled with the electrolyte 1 from example 1;

FIG. 9 shows the potential in [V] as a function of the capacity, which is related to the theoretical capacity of the negative electrode, of three wound cells having electrodes that have different binder combinations and planar discharge elements and that are filled with the electrolyte 1 from example 1, while charging during a cover layer formation on the negative electrode;

FIG. 10 shows the discharge capacity as a function of the number of cycles of two wound cells having electrodes which have different binder combinations and planar discharge elements and which are filled with the electrolyte 1 from example 1;

FIG. 11 shows the potential in [V] as a function of the capacity, which is related to the theoretical capacity of the negative electrode, of three test full-cells, which were filled with the electrolytes 1 and 3 and the lithium tetrachloroaluminate electrolyte from example 1, while charging during a cover layer formation on the negative electrode;

FIG. 12 shows the potential trend during discharge, in volts [V], as a function of the charge percentage, of three test full-cells that were filled with the electrolytes 1, 3, 4 and 5 from example 1 and contained lithium nickel manganese cobalt oxide (NMC) as the active electrode material;

FIG. 13 shows the conductivities in [mS/cm] of electrolytes 1 and 4 from example 1 as a function of the concentration of compounds 1 and 4; and

FIG. 14 shows the conductivities in [mS/cm] of the electrolytes 3 and 5 from example 1 as a function of the concentration of the compounds 3 and 5.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

It shall be understood for purposes of this disclosure and appended claims that, regardless of whether the phrases “one or more” or “at least one” precede an element or feature appearing in this disclosure or claims, such element or feature shall not receive a singular interpretation unless it is made explicit herein. By way of non-limiting example, the terms “positive electrode,” “negative electrode,” “conductive salt,” “additive” and “binder,” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

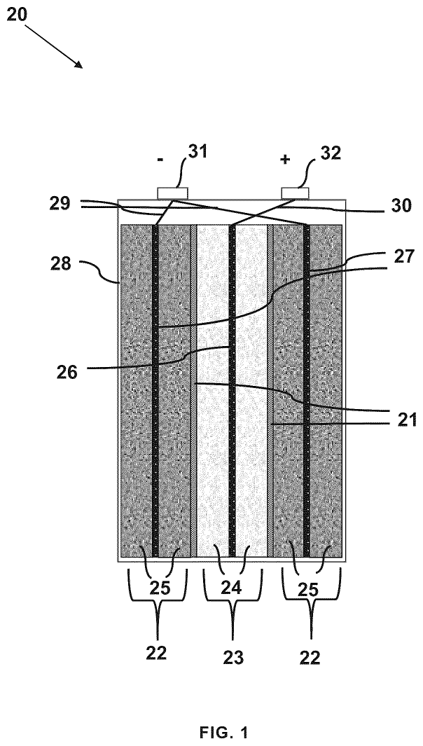

FIG. 1 shows a cross-sectional view of a first exemplary embodiment of a rechargeable battery cell 20 according to this disclosure. This first exemplary embodiment shows an electrode arrangement including a positive electrode 23 and two negative electrodes 22. The electrodes 22, 23 are each separated from one another by separators 21 and surrounded by a housing 28. The positive electrode 23 comprises a discharge element 26 in the form of a planar metal foil to which a homogeneous mixture of the active material 24 of the positive electrode 23, a first binder SBR and a second binder CMC is applied on both sides. The negative electrodes 22 also comprise a discharge element 27 in the form of a planar metal foil to which a homogeneous mixture of the active material 25 of the negative electrode 22, the first binder SBR and the second binder CMC is applied on both sides. Alternatively, the planar discharge elements of the edge electrodes, that is to say the electrodes which complete the electrode stack, may only be coated with active material on one side. The non-coated side faces the wall of the housing 28. The electrodes 22, 23 are connected to corresponding terminal contacts 31, 32 of the rechargeable battery cell 20 via electrode connections 29, 30.

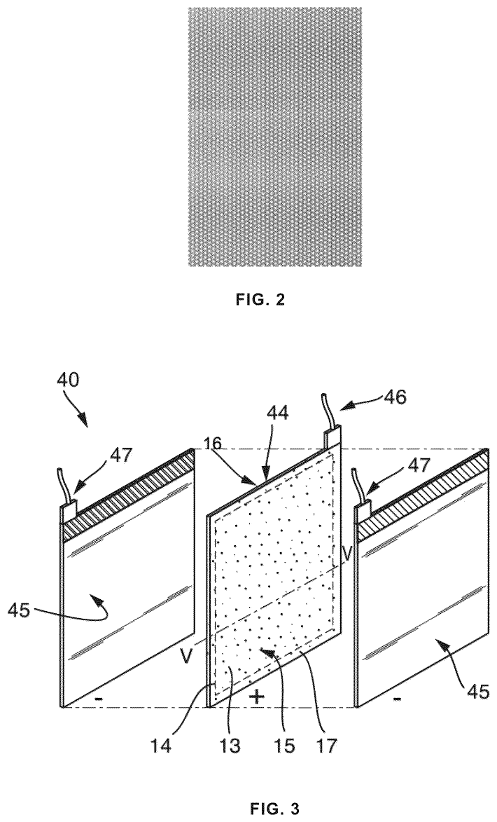

FIG. 2 shows the planar metal foil which serves as a discharge element 26, 27 for the positive electrodes 23 and the negative electrodes 22 in the second exemplary embodiment from FIG. 1. This metal foil has a perforated or net-like structure with a thickness of 20 μm.

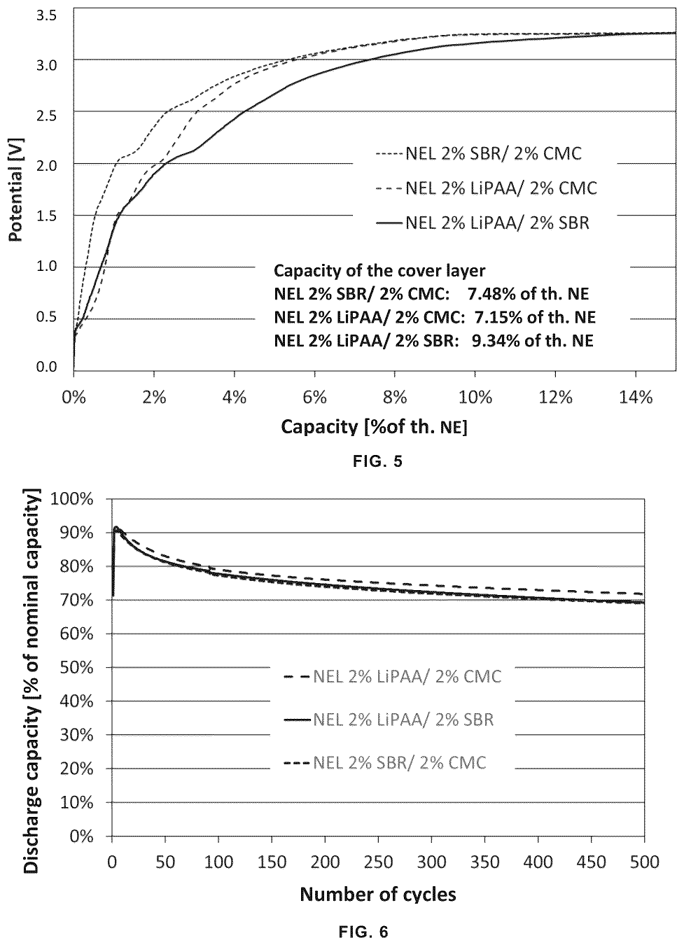

FIG. 3 shows a second exemplary embodiment of the rechargeable battery cell 40 according to this disclosure in an exploded view. This second exemplary embodiment differs from the first exemplary embodiment explained above in that the positive electrode 44 is enclosed by an enclosure 13 which serves as a separator. In this case, a surface area extent of the enclosure 13 is greater than a surface area extent of the positive electrode 44, the boundary 14 of which is drawn in as a dashed line in FIG. 5. Two layers 15, 16 of the enclosure 13, which cover the positive electrode 44 on both sides, are connected to one another by an edge connection 17 at the peripheral edge of the positive electrode 44. The two negative electrodes 45 are not enclosed. The electrodes 44 and 45 may be contacted via the electrode connections 46 and 47.

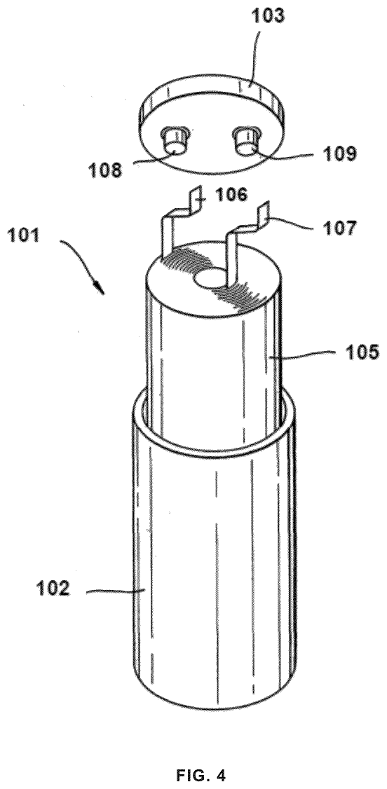

FIG. 4 shows a third exemplary embodiment of a rechargeable battery cell 101 according to this disclosure in an exploded view. The essential structural elements of a battery cell 101 with a wound electrode arrangement are shown. In a cylindrical housing 102 with a cover part 103, there is an electrode arrangement 105 which is wound from a web-like starting material. The web consists of a plurality of layers including a positive electrode, a negative electrode, and a separator running between the electrodes, the separator electrically and mechanically insulating the electrodes from one another but being sufficiently porous or ionically conductive to allow the necessary ion exchange. The positive electrode comprises a discharge element in the form of a planar metal foil to which a homogeneous mixture of the active material 24 of the positive electrode 23, a first binder SBR and a second binder CMC is applied on both sides. The negative electrode also comprises a discharge element in the form of a planar metal foil to which a homogeneous mixture of the active material 25 of the negative electrode 22, the first binder SBR and the second binder CMC is applied on both sides.

The cavity of the housing 102, insofar as it is not occupied by the electrode arrangement 105, is filled with an electrolyte (not shown). The positive and negative electrodes of the electrode arrangement 105 are connected via corresponding terminal lugs 106 for the positive electrode and 107 for the negative electrode to the terminal contacts 108 for the positive electrode and 109 for the negative electrode, the lugs enabling the rechargeable battery cell 101 to be electrically connected. As an alternative to the electrical connection of the negative electrode shown in FIG. 4, using the terminal lug 107 and the terminal contact 109, the electrical connection of the negative electrode may also be accomplished via the housing 102.

### Example 1: Production of Exemplary Embodiments of an SO₂-Based Electrolyte for a Battery Cell

The electrolyte LiAlCl₄*x SO₂ used for the experiments described below was produced according to the method described in patent specification EP 2 954 588 B1 (hereinafter referred to as [V6]). First, lithium chloride (LiCl) was dried under vacuum at 120° C. for three days. Aluminum particles (Al) were dried under vacuum at 450° C. for two days. LiCl, aluminum chloride (AlCl₃) and Al were mixed together in a molar ratio AlCl₃:LiCl:Al of 1:1.06:0.35 in a glass bottle with an opening allowing gas to escape. Thereafter, this mixture was heat-treated in stages to prepare a molten salt. After cooling, the molten salt formed was filtered, then cooled to room temperature and finally SO₂ was added until the desired molar ratio of SO₂ to LiAlCl₄ was achieved. The electrolyte formed in this way had the composition LiAlCl₄*x SO₂, where x is dependent on the amount of SO₂ supplied. In the experiments, this electrolyte is called a lithium tetrachloroaluminate electrolyte.

For the experiments described below, five exemplary embodiments 1, 2, 3, 4 and 5 of the SO₂-based electrolyte were also produced using a conductive salt of the formula (I) (hereinafter referred to as electrolytes 1, 2, 3, 4 and 5). For this purpose, five different first conductive salts according to formula (I) were first produced according to a production process described in the following documents [V7], [V8] and [V9]:
[V7] “I Krossing, Chem. Eur. J. 2001, 7, 490;
[V8] S M Ivanova et al., Chem. Eur. J. 2001, 7, 503;
[V9] Tsujioka et al., J. Electrochem. Soc., 2004, 151, A1418”

These five different first conductive salts according to formula (I) are referred to below as compounds 1, 2, 3, 4 and 5. They come from the family of polyfluoroalkoxyaluminates and were prepared in hexane according to the following reaction equation starting from LiAlH₄ and the corresponding alcohol R—OH with R¹=R²=R³=R⁴.

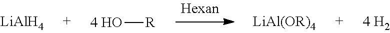

As a result, the compounds 1, 2, 3, 4 and 5 shown below were formed with the following molecular and structural formulas:

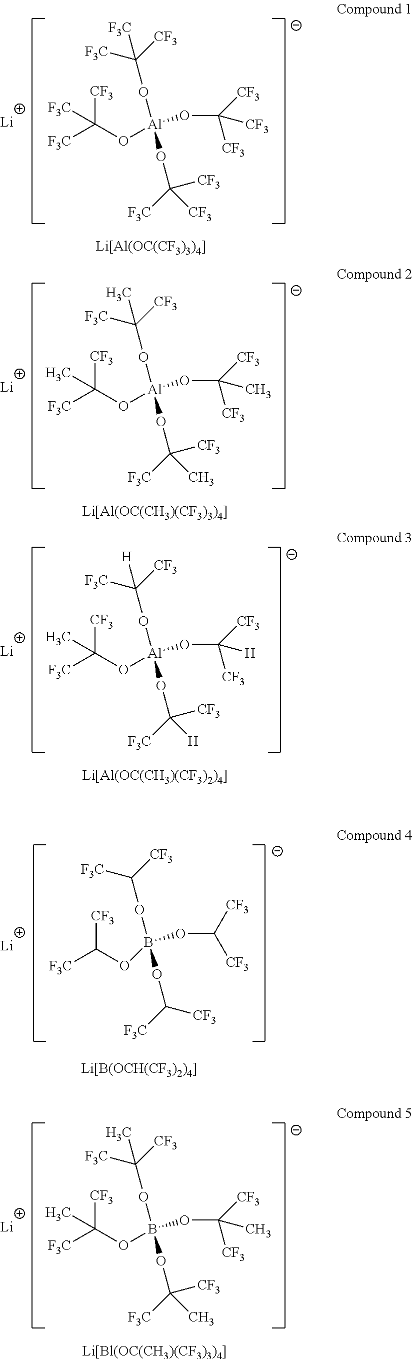

For purposes of purification, compounds 1, 2, 3, 4 and 5 were first recrystallized. This removed residues of the starting material LiAlH₄ from the first conductive salt since this starting material could possibly lead to sparking with any traces of water present in SO₂.

Then the compounds 1, 2, 3, 4 and 5 were dissolved in SO₂. Here it was found that the compounds 1, 2, 3, 4 and 5 dissolve well in SO₂.

The preparation of the electrolytes 1, 2, 3, 4 and 5 was carried out at low temperature or under pressure according to the process steps 1 to 4 listed below:
1) Placement of the respective compound 1, 2, 3, 4 and 5 into a pressure piston with riser pipe, respectively,
2) Evacuating the pressure pistons,
3) Inflow of liquid SO₂ and
4) Repeat steps 2+3 until the target amount of SO₂ has been added.

The respective concentration of the compounds 1, 2, 3, 4 and 5 in the electrolytes 1, 2, 3, 4 and 5 was 0.6 mol/l (molar concentration based on 1 liter of the electrolyte), unless otherwise stated in the experiment description.

Using the lithium tetrachloroaluminate electrolyte and the electrolytes 1, 2, 3, 4 and 5, the experiments described below were carried out.

### Example 2: Production of Test Full-Cells

The test full-cells used in the experiments described below are rechargeable battery cells with two negative electrodes and one positive electrode, each separated by a separator. The positive electrodes comprised an active material, a conductivity promoter, and two binders. The negative electrodes contained graphite as an active material and also two binders. As mentioned in the experiment, the negative electrodes can also contain a conductivity additive. The active material of the positive electrode is named in each experiment. Among other things, the aim of the investigations is to confirm the use of different binders or a combination of binders for electrodes having planar discharge elements in a battery cell according to this disclosure with an SO₂-based electrolyte. Table 2a shows which binders were tested. Table 2b shows the binder combinations used in the experiments.

The test full-cells were each filled with the electrolyte required for the experiments, i.e., either with the lithium tetrachloroaluminate electrolyte or with electrolytes 1, 2, 3, 4 or 5. In most cases, several, i.e., two to four identical test full-cells were produced for each experiment. The results presented in the experiments are then in each case mean values from the measured values obtained for the identical test full-cells.

TABLE 2a
Examined Binders

| Binder | Abbreviation |
|---|---|
| Styrene butadiene rubber (as an example of the | SBR |
| first binder) | |
| Carboxymethyl cellulose (as an example for the | CMC |
| second binder) | |
| Polyvinylidene fluoride (as an example for the | PVDF |
| third binder) | |
| Lithium polyacrylate (as an example of the fourth | LiPAA |
| binder) | |

TABLE 2b
Overview Experiments (% Corresponds to wt %)

| | | Type of Discharge |
|---|---|---|
| Experiment | Binder Combinations | Element/Electrolyte |
| 1 | 2.0% LiPAA/2.0% CMC | Three-Dimensional/ |
| | 2.0% LiPAA/2.0% SBR | Lithium |
| | 2.0% SBR/2.0% CMC | Tetrachloroaluminate |
| | | Electrolyte |
| 2 Adhesion | 1.0% CMC/2.0% LiPAA/1.0% | Planar |
| | SBR 1.0% SBR/2.0% CMC | |
| 2 Loading | 2.0% LiPAA/2.0% CMC | Planar |
| | 2.0% SBR/2.0% CMC | |
| 3 | 3.0% SBR/1.0% CMC | Planar/Electrolyte 1 |
| | 2.0% SBR/2.0% CMC | |
| | 2.0-4.0% PVDF | |
| 4 Top Layer | 2.5% SBR/1.5% CMC | Planar/Electrolyte 1 |
| Capacity | 2.0% SBR/2.0% CMC | |
| | 1.0% SBR/2.0% CMC | |
| 4 Discharge | 2.5% SBR/1.5% CMC | Planar/Electrolyte 1 |
| Capacity | 2.0% SBR/2.0% CMC | |
| 5-7 | Investigation of Electrolyte | Electrolyte 1, |
| | Properties | Electrolyte 3 |
| | | Electrolyte 4, |
| | | Electrolyte 5 |

### Example 3: Measurement in Test Cull-Cells

### Cover Layer Capacity:

The capacity used up in the first cycle for the formation of a cover layer on the negative electrode is an important criterion for the quality of a battery cell. This cover layer is formed on the negative electrode when the test full-cell is first charged. Lithium ions are irreversibly consumed for this cover layer formation (cover layer capacity) so that the test full-cell has less cyclable capacity for the subsequent cycles. The cover layer capacity, in % of theoretical, used to form the cover layer on the negative electrode is calculated using the following formula:

Cover layer capacity [in % of theoretical]=(Q_{ch}(x mAh)−Q_{dis}(y mAh))/Q_{NEL}

Q_{ch} describes the amount of charge specified in the respective experiment in mAh; Q_{dis} describes the amount of charge in mAh that was obtained when the test full-cell was subsequently discharged. Q_{NEL} is the theoretical capacity of the negative electrode used. In the case of graphite, for example, the theoretical capacity is calculated to be 372 mAh/g.

### Discharge Capacity:

For measurements in test full-cells, for example, the discharge capacity is determined via the number of cycles. To do this, the test full-cells are charged at a specific charging current up to a specific upper potential. The corresponding upper potential is maintained until the charging current has dropped to a specific value. The discharge then takes place at a specific discharge current down to a specific discharge potential. This charging method is referred to as an I/U charging. This process is repeated depending on the desired number of cycles.

The upper potentials or the discharge potential and the respective charging or discharging currents are named in the experiments. The value to which the charging current must have dropped is also described in the experiments.

The term “upper potential” is used synonymously with the terms “charging potential,” “charging voltage,” “end of charge voltage” and “upper potential limit.” These terms describe the voltage/potential to which a cell or battery is charged using a battery charger.

The battery is preferably charged at a current rate of C/2 and at a temperature of 22° C. By definition, at a charge or discharge rate of 1C, the nominal capacity of a cell is charged or discharged in one hour. A charge rate of C/2 therefore means a charge time of 2 hours.

The term “discharge potential” is used synonymously with the term “lower cell voltage.” This is the voltage/potential to which a cell or battery is discharged using a battery charger.

Preferably, the battery is discharged at a current rate of C/2 and at a temperature of 22° C.

The discharge capacity is obtained from the discharge current and the time until the discharge termination criteria are met. The associated figures show mean values for the discharge capacities as a function of the number of cycles. These mean values of the discharge capacities are often normalized to the maximum capacity that was achieved in the respective test, expressed as a percentage of the nominal capacity.

### Experiment 1: Investigations of Different Binder Combinations in Test Full-Cells Having a Three-Dimensional Discharge Element

Rechargeable batteries having an SO₂-based electrolyte from the prior art mainly use electrodes comprising a three-dimensional discharge element, for example, made of nickel foam (cf. [V5]). A preferred binder for the negative electrode is lithium polyacrylate (LiPAA) (cf. [V4]). Negative electrodes (NEL) were fabricated with graphite as the active material and different binder combinations. All electrodes included the three-dimensional discharge element known from the prior art in the form of a nickel foam. The binder combinations are
2 wt % LiPAA/2 wt % CMC,
2 wt % LiPAA/2 wt % SBR and
2 wt % SBR/2 wt % CMC.

Two identical negative electrodes each were joined together with a positive electrode containing lithium iron phosphate (LEP) as the active electrode material to form a test full-cell 1 according to example 2. Three test full-cells were obtained which differed in the binder combination within the negative electrode. All three test full-cells were filled with a lithium tetrachloroaluminate electrolyte according to example 1, having the composition LiAlCl₄*6 SO₂.

First, in the first cycle, the cover layer capacities were determined according to example 3.

To do this, the test full-cells were charged at a current of 15 mA until a capacity of 125 mAh (Q_{ch}) was reached. The test full-cells were then discharged at 15 mA until a potential of 2.5 volts was reached. The discharge capacity (Q_{dis}) was thereby determined.

FIG. 5 shows the potential, in volts, of the various respective test full-cells when charging the negative electrode, as a function of the capacity in [%], which is related to the theoretical capacity of the negative electrode.

The determined cover layer capacities [in % of the theoretical capacity of the negative electrode] of the different negative electrodes are at the following values:
NEL 2% SBR/2% CMC: 7.48% of th. NE
NEL 2% LiPAA/2% CMC: 7.15% of th. NE
NEL 2% LiPAA/2% SBR: 9.34% of th. NE

The cover layer capacities are lowest with the binder combination 2% LiPAA/2% CMC.

To determine the discharge capacities (see example 3), the test full-cells were charged at a current of 100 mA up to an upper potential of 3.6 volts. The potential of 3.6 volts was maintained until the current dropped to 40 mA. Thereafter, the discharge took place at a discharge current of 100 mA down to a discharge potential of 2.5 volts.

FIG. 6 shows mean values for the discharge capacities of the test full-cells as a function of the number of cycles. 500 cycles were performed. These mean values of the discharge capacities are each expressed as a percentage of the nominal capacity [% nominal capacity].

The trend of the discharge capacities of the test full-cells shows an even, slightly decreasing trend. However, the decrease in capacity is lowest in those test full-cells that contained graphite electrodes having the binder combination 2% LiPAA/2% CMC.

When using a three-dimensional discharge element in the form of the nickel foam discharge element, the negative electrode having the binder combination 2% LiPAA/2% CMC shows a lower cover layer capacity and better cycle behavior than the negative electrodes having the binder combinations 2% LiPAA/2% SBR or 2% SBR/2% CMC. This also confirms the statements made in [V4] that a binder containing LiPAA has a positive effect when using a three-dimensional discharge element in the form of a nickel foam discharge element.

### Experiment 2: Mechanical Investigations of Graphite Using Different Binders on a Planar Conductor Element

In order to investigate the properties of graphite using different binders on a planar conductor element, at first, mechanical investigations were carried out. On the one hand, values for the adhesion of the electrode mass to the planar discharge element were determined and, on the other hand, tests were carried out on the loading, i.e., the amount of active mass per cm² of electrode area.

To investigate the adhesion of graphite using two different binder combinations on a planar discharge element, tests were carried out using a model T1000 tensile/compression testing machine by MFC Sensortechnik. The investigations were 900 peel tests. A peel test is used to check the properties of a film bonded to a substrate by means of a tensile test. The coated foils to be tested were fastened to a carrier plate, then a free end was clamped into the tensile testing machine and pulled upwards at a constant speed of 100 mm/min. The planar discharge element in the form of a conductive foil was detached from the electrode layer and the adhesive force along the electrode foil was recorded. Two graphite electrodes having the binders CMC-LiPAA-SBR (1%-2%-1%) (electrode 1) and the binders CMC-SBR (2%-1%) (electrode 2) were examined on a metal foil as a planar discharge element. Table 3 shows the results of the adhesion measurements.

TABLE 3
Results of Adhesion Measurements

| | Electrode 1 | Electrode 2 |
|---|---|---|
| Binder Combination | CMC-LiPAA-SBR | CMC SBR |
| | (1%-2%-1%) | (2%-1%) |
| Adhesion (N/m) | 5.4 | 13.4 |

The graphite using the binder combination with an LiPAA fraction has a significantly lower adhesion value than that of graphite using the binder combination without an LiPAA fraction. This means that in the case of electrode 1, the adhesion of the graphite on the discharge element is poorer, and mechanical loads during operation of the battery cell can lead to the electrode mass flaking off. In contrast, electrodes having the CMC/SBR binder combination adhere well to the planar discharge element.

The possible loading, i.e., the amount of active mass per cm² of electrode area, of a planar discharge element was investigated. To produce planar electrodes, a mixture of graphite and binders was prepared and processed into a homogeneous paste together with a solvent. The finished paste was applied homogeneously to a metal foil and dried in air or in an oven at low temperatures. This step is necessary to make the electrodes solvent-free. After cooling, the electrode was compacted using a calendar.

On the one hand, graphite electrodes having a binder mixture of LiPAA (2 wt %) and CMC (2 wt %) and on the other hand graphite electrodes having a binder mixture of SBR (2 wt %) and CMC (2 wt %) were produced. Due to the poorer mechanical properties of LiPAA on planar electrodes, only about 5 mg/cm² of graphite/binder could be applied to the metal foil. When using the SBR/CMC binder mixture, a desired application of 14 mg/cm² was achieved. The combination of SBR/CMC binders is well suited for producing electrodes with a high charge and thus a high capacity.

Experiment 3: Investigations of Different Binder Combinations in Half-Cells Having Planar Discharge Elements and Filled with Electrolyte 1

First, graphite electrodes having different binder combinations were examined in half-cells with a three-electrode arrangement, the reference- and counter-electrodes each consisting of metallic lithium. The electrolyte used in the half-cell was electrolyte 1 according to example 1. The following binder combinations on a planar discharge element were used:
Graphite electrode with 3.0 wt % SBR and 1.0 wt % CMC
Graphite electrode with 2.0 wt % SBR and 2.0 wt % CMC
Graphite electrode with approx. 2.0-4.0 wt % PVDF

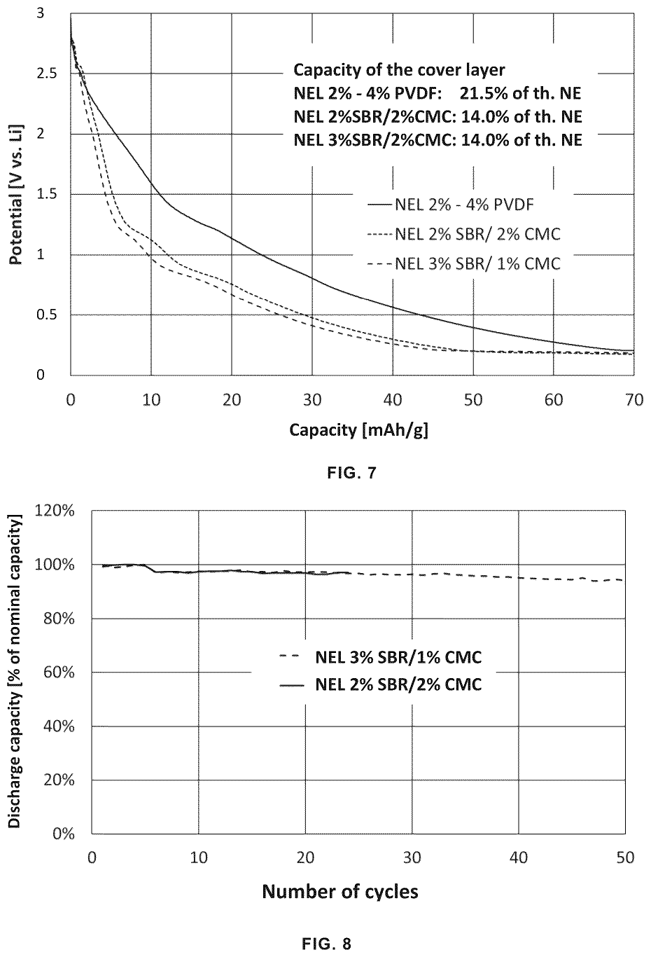

Since the prior art (see [V3] and [V5]) also proposes PVDF as a suitable binder, graphite electrodes having this binder were also examined. First, the cover layer capacities were determined. For this purpose, the half-cells were charged at a rate of 0.1 C to a potential of 0.03 V and discharged at the same rate to a potential of 0.5 V. The cover layer capacity was calculated from the capacity loss of the first cycle. FIG. 7 shows the potential, in volts, of the various test full-cells when charging the negative electrode, as a function of the capacity in [%], which is related to the theoretical capacity of the negative electrode.

The determined cover layer capacities [in % of the theoretical capacity of the negative electrode] are as follows for the different electrodes:
NEL 3% SBR/1% CMC: 14.0% of th. NE
NEL 2% SBR/2% CMC: 14.0% of th. NE
NEL 2.0-4.0 wt % PVDF: 21.5% of th. NE

The cover layer capacity of the negative electrode having a PVDF binder is very high at 21.5%. This means that almost a quarter of the battery capacity is already used up for the formation of the cover layer. The sole use of PVDF binder for electrodes having a planar discharge element is not suitable in rechargeable battery cells with an SO₂-based electrolyte. However, this PVDF binder can be used as an additional, third binder alongside the SBR/CMC binder combination.

The electrodes having SBR/CMC binder, on the other hand, have a lower cover layer capacity.

To determine the discharge capacities (see example 3), the half-cells having SBR/CMC binder where charged, in cycles 1 to 5, at a charging rate of 0.1 C up to a potential of 0.03 volts and were discharged down to a potential of 0.5 volts. Beginning at cycle 6, the charge and discharge rate was increased to 1 C. In addition, the potential of 0.03 volts was maintained during charging until the charging rate had dropped to 0.01 C.

FIG. 8 shows mean values for the discharge capacities of the two half-cells as a function of the number of cycles. 25 (2% SBR/2% CMC) and 50 (3% SBR/1% CMC) cycles were carried out. These mean values of the discharge capacities are each expressed as a percentage of the nominal capacity [% nominal capacity]. Both half-cells show a stable trend of the discharge capacity. The combination of SBR and CMC binder is very well suited for electrodes having a planar discharge element in the SO₂-based electrolyte.

Experiment 4: Investigations of Different Binder Combinations in Wound Cells with Planar Discharge Elements and Filled with Electrolyte 1

In addition to the half-cell experiments, wound cells having a positive electrode containing lithium nickel manganese cobalt oxide (NMC811) as the active material and a negative graphite electrode having the following binder combinations were investigated:
2.5 wt % SBR/1.5 wt % CMC
2.0 wt % SBR/2.0 wt % CMC
1.0 wt % SBR/2.0 wt % CMC

First, in the first cycle, the cover layer capacities were determined according to example 3. For this purpose, the wound cells were charged at a current of 0.1 A until a capacity of 0.9 Ah (Q_{ch}) was reached. The wound cells were then discharged at 0.1 A until a potential of 2.5 volts was reached. From this, the discharge capacity (Q_{dis}) was determined.

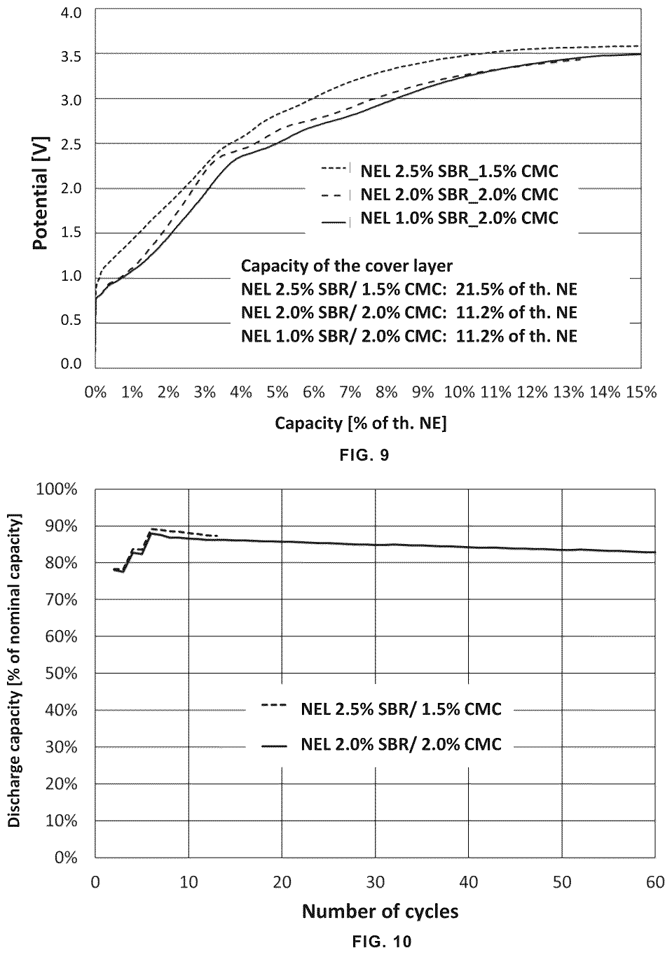

FIG. 9 shows the potential, in volts, of the respective various wound cells while charging the negative electrode, as a function of the capacity in [%], the capacity being related to the theoretical capacity of the negative electrode. In the three wound cells examined, the cover layer capacities determined [in % of the theoretical capacity of the negative electrode] are approx. 11% of the theoretical NE, and are thus good values.

To determine the discharge capacities (see example 3), the wound cells having the binder combinations 2.5% SBR/1.5% CMC and 2.0% SBR/2.0% CMC were charged at a current of 0.2 A up to an upper potential of 4.2 volts. Thereafter, the discharge took place at a discharge current of 0.2 A down to a discharge potential of 2.8 volts. The charge voltage was increased to 4.4 volts and then to 4.6, which was maintained for all subsequent cycles.

FIG. 10 shows mean values for the discharge capacities of the wound cells as a function of the number of cycles. 15 (2.5% SBR/1.5% CMC) and 60 (2.0% SBR/2.0% CMC) cycles were carried out. These mean values of the discharge capacities are each expressed as a percentage of the nominal capacity [% nominal capacity].

The trend of the discharge capacities of both winding cells shows an even, slightly decreasing trend. The combination of SBR and CMC binder is also very well suited for full-cells comprising the SO₂-based electrolyte and having electrodes with a planar discharge element.

### Experiment 5: Examination of the Electrolytes 1, 3, 4 and 5

Various experiments were carried out to investigate the electrolytes 1, 3, 4 and 5. First of all, the cover layer capacities of the electrolytes 1 and 3 and the lithium tetrachloroaluminate electrolyte were determined, and secondly the discharge capacities in the electrolytes 1, 3, 4 and 5 were determined.

To determine the cover layer capacity, three test full-cells were filled with the electrolytes 1 and 3 and the lithium tetrachloroaluminate electrolyte described in example 1. The three test full-cells contained lithium iron phosphate as the positive electrode active material.

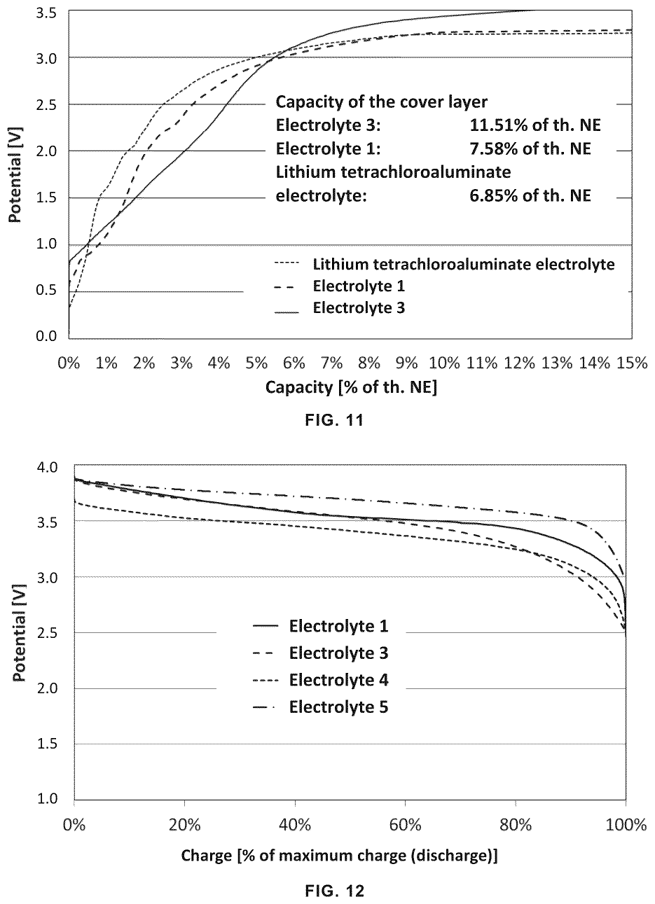

FIG. 11 shows the potential, in volts, of the test full-cells during charging, as a function of the capacity, which is related to the theoretical capacity of the negative electrode. The two curves shown show averaged results of several experiments using the test full-cells described above. First, the test full-cells were charged at a current of 15 mA until a capacity of 125 mAh (Q_{ch}) was reached. The test full-cells were then discharged at 15 mA until a potential of 2.5 volts was reached. The discharge capacity (Q_{dis}) was thereby determined.

The absolute capacity losses are 7.58% and 11.51% for electrolytes 1 and 3, respectively, and 6.85% for the lithium tetrachloroaluminate electrolyte. All electrolytes have a low cover layer capacity.

For the discharge experiments, three test full-cells were filled according to example 2 with the electrolytes 1, 3, 4 and 5 described in example 1. The test full-cells had lithium nickel manganese cobalt oxide (NMC) as the positive electrode active material. To determine the discharge capacities (see example 3), the test full-cells were charged at a current of 15 mA up to a capacity of 125 mAh. Thereafter, the discharge took place at a current of 15 mA down to a discharge potential of 2.5 volts.

FIG. 12 shows the trend of the potential during discharge versus the amount of charge discharged in % [% of the maximum charge (discharge)]. All test full-cells show a flat discharge curve, which is necessary for good battery cell operation.

### Experiment 6: Determination of Conductivities of Electrolytes 1, 3, 4 and 5

To determine the conductivity, the electrolytes 1, 3, 4 and 5 were prepared at different concentrations of the compounds 1, 3, 4 and 5. For each concentration of the different compounds, the conductivities of the electrolytes were determined using a conductive measurement method. After temperature control, a four-electrode sensor was held in the solution while stirring, measurements being made in a measuring range of 0.02-500 mS/cm.

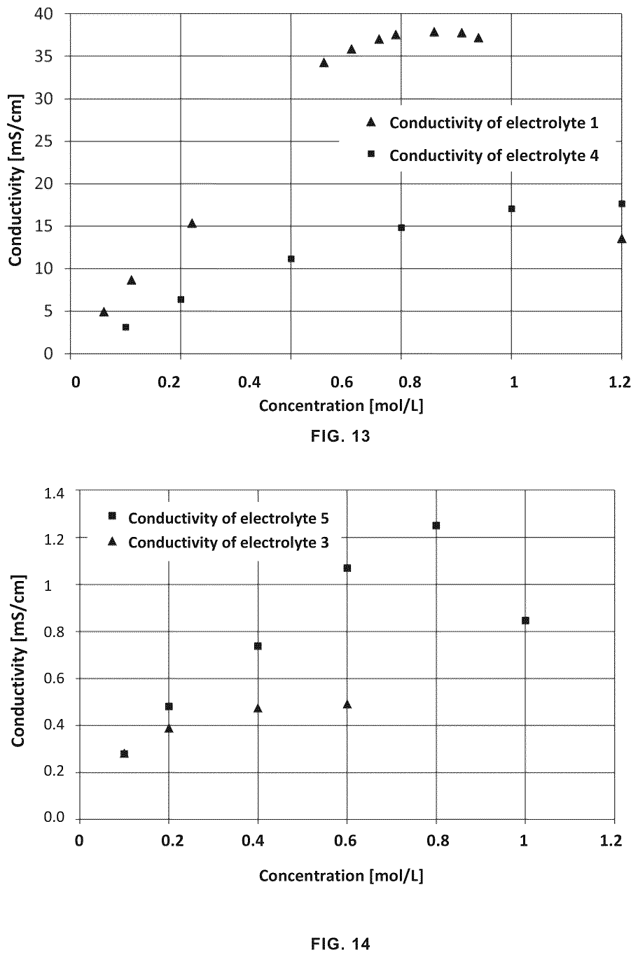

FIG. 13 shows the conductivities of electrolytes 1 and 4 as a function of the concentration of compounds 1 and 4. In the case of electrolyte 1, a conductivity maximum can be seen at a concentration of compound 1 of 0.6 mol/L-0.7 mol/L with a value of approx. 37.9 mS/cm. In comparison, the organic electrolytes known from the prior art, such as LP30 (1 M LiPF₆/EC-DMC (1:1 by weight)) have a conductivity of only approx. 10 mS/cm. For electrolyte 4, a maximum of 18 mS/cm is achieved at a conductive salt concentration of 1 mol/L.

FIG. 14 shows the conductivities of the electrolytes 3 and 5 as a function of the concentration of the compounds 3 and 5.

For electrolyte 5, a maximum of 1.3 mS/cm is achieved at a conductive salt concentration of 0.8 mol/L. Electrolyte 3 shows its highest conductivity of 0.5 mS/cm at a conductive salt concentration of 0.6 mol/L. Although the electrolytes 3 and 5 show lower conductivities, charging and discharging a test half-cell, as described, for example, in experiment 3, or a test full-cell as described in experiment 8, is quite possible.

### Experiment 7: Low Temperature Behavior

In order to determine the low-temperature behavior of the electrolyte 1 in comparison to the lithium tetrachloroaluminate electrolyte, two test full-cells were prepared according to example 2. A test full-cell was filled with lithium tetrachloroaluminate electrolyte having the composition LiAlCl₄*6SO₂ and the other test full-cell was filled with electrolyte 1. The test full-cell having the lithium tetrachloroaluminate electrolyte contained lithium iron phosphate (LEP) as the active material, and the test cell having electrolyte 1 contained lithium nickel manganese cobalt oxide (NMC) as the positive electrode active material. The test full-cells were charged at 20° C. to 3.6 volts (LEP) and 4.4 volts (NMC) and discharged to 2.5 volts at the respective temperature to be examined. The discharge capacity reached at 20° C. was set as 100%. The discharge temperature was lowered in 10° K temperature steps. The discharge capacity reached was described in % of the discharge capacity at 20° C. Since the low-temperature discharges are nearly independent of the active materials used in the positive and negative electrodes, the results can be transferred to all combinations of active materials. Table 5 shows the results.

TABLE 5
Discharge Capacities as a Function of Temperature

| | Discharge Capacity of | Discharge Capacity of the Lithium |
|---|---|---|
| Temperature | Electrolyte 1 | Tetrachloroaluminate Electrolyte |
| 20° C. | 100% | 100% |
| 10° C. | 99% | 99% |
| 0° C. | 95% | 46% |
| −10° C. | 89% | 21% |
| −20° C. | 82% | n/a |
| −30° C. | 73% | n/a |
| −35° C. | 68% | n/a |
| −40° C. | 61% | n/a |

The test full-cell having electrolyte 1 shows very good low-temperature behavior. At −20° C., 82% of the capacity has still been reached, at −30° C., 73% has been reached. Even at a temperature of −40° C., 61% of the capacity can still be discharged. In contrast to this, the test full-cell having the lithium tetrachloroaluminate electrolyte only shows a discharge capacity down to −10° C. A capacity of 21% is reached. At lower temperatures, the cell with the lithium tetrachloroaluminate electrolyte can no longer be discharged.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A rechargeable battery cell, comprising:
an active metal;
a positive electrode having a planar discharge element;
a negative electrode having a planar discharge element;
a housing; and
an SO₂-based electrolyte containing a first conductive salt, wherein the positive and/or the negative electrode comprises a first binder consisting of a polymer based on monomeric styrene and butadiene structural units, and a second binder selected from the group consisting of carboxymethyl celluloses.

2. The rechargeable battery cell according to claim 1, wherein the positive electrode and/or the negative electrode contains a further binder that differs from the first and second binders.

3. The rechargeable battery cell according to claim 2, wherein the further binder comprises a fluorinated binder.

4. The rechargeable battery cell of claim 3, wherein the fluorinated binder is a polyvinylidene fluoride and/or a terpolymer of tetrafluoroethylene, hexafluoropropylene and vinylidene fluoride.

5. The rechargeable battery cell according to claim 2, wherein the further binder comprises a polymer built up from monomeric structural units of a conjugated carboxylic acid or from the alkali, alkaline earth or ammonium salt of said conjugated carboxylic acid or from a combination thereof.

6. The rechargeable battery cell according to claim 1, wherein the concentration of all binders in the positive or negative electrode is selected from the group consisting of: at most 20 wt %, at most 15 wt %, at most 10 wt %, at most 7 wt %, at most 5 wt %, at most 2 wt %, at most 1 wt % and at most 0.5 wt % relative to the total weight of the positive or negative electrode.

7. The rechargeable battery cell according to claim 1, wherein the first conductive salt is selected from the group consisting of:
an alkali metal compound; and
a conductive salt having the formula (I) 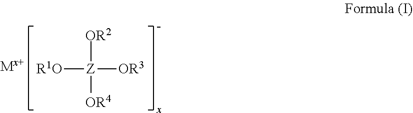
wherein;
M is a metal selected from the group consisting of alkali metals, alkaline earth metals, group 12 metals of the periodic table of elements, and aluminum;
x is a number from 1 to 3;
the substituents R¹, R², R³ and R⁴ are independently selected from the group consisting of C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl; and
where Z is aluminum or boron.

8. The rechargeable battery cell according to claim 7, wherein the first conductive salt comprises the alkali metal compound, the alkali metal compound being a lithium compound.

9. The rechargeable battery cell according to claim 8, wherein the lithium compound is selected from the group consisting of lithium tetrahalogenoaluminate, a halide, an oxalate, a borate, a phosphate, an arsenate and a gallate.

10. The rechargeable battery cell according to claim 7, wherein the substituents R¹, R², R³ and R⁴ of the first conductive salt are independently selected from the group consisting of:
C₁-C₆ alkyl;
C₂-C₆ alkenyl;
C₂-C₆ alkynyl;
C₃-C₆ cycloalkyl;
phenyl; and
C₅-C₇ heteroaryl.

11. The rechargeable battery cell according to claim 10, wherein at least one of the substituents R¹, R², R³ and R⁴ of the first conductive salt comprises C₂-C₄ alkyl.

12. The rechargeable battery cell according to claim 10, wherein at least one of the substituents R¹, R², R³ and R⁴ of the C₁-C₆ alkyl comprises a 2-propyl, methyl, or ethyl group.

13. The rechargeable battery cell according to claim 10, wherein at least one of the substituents R¹, R², R³ and R⁴ of the first conductive salt comprises C₂-C₄ alkenyl.

14. The rechargeable battery cell according to claim 13, wherein at least one of the substituents R¹, R², R³ and R⁴ of the C₂-C₄ alkenyl comprises an ethenyl or propenyl group.

15. The rechargeable battery cell according to claim 10, wherein at least one of the substituents R¹, R², R³ and R⁴ of the first conductive salt comprises C₂-C₄ alkynyl.

16. The rechargeable battery cell according to claim 7, wherein at least one of the substituents R¹, R², R³ and R⁴ of the first conductive salt is substituted by at least one fluorine atom and/or by at least one chemical group selected from the group consisting of C₁-C₄ alkyl, C₂-C₄ alkenyl, C₂-C₄ alkynyl, phenyl and benzyl.

17. The rechargeable battery cell according to claim 7, wherein at least one of the substituents R¹, R², R³ and R⁴ of the first conductive salt is a CF₃ group or an OSO₂—CF₃ group.

18. The rechargeable battery cell according to claim 7, wherein the first conductive salt is selected from the group consisting of:

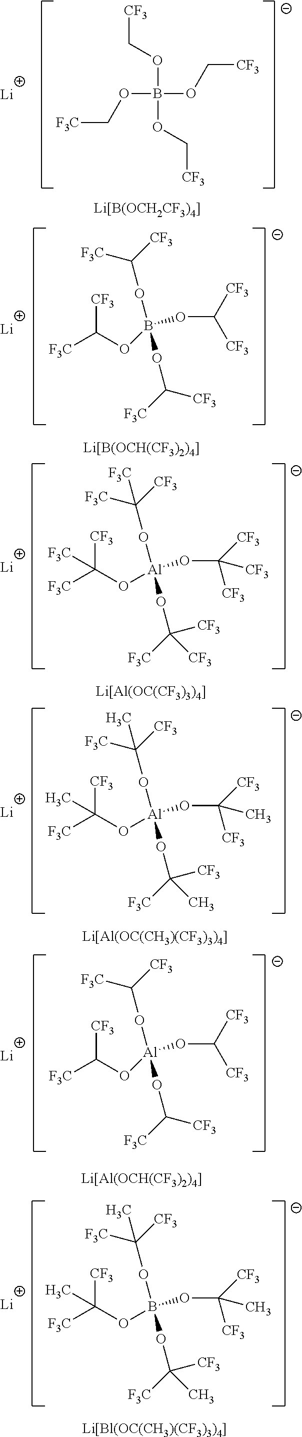

19. The rechargeable battery cell according to claim 1, wherein the electrolyte contains at least one second conductive salt that differs from the first conductive salt.

20. The rechargeable battery cell according to claim 1, wherein the electrolyte contains an additive.

21. The rechargeable battery cell according to claim 20, wherein the additive is selected from the group consisting of vinylene carbonate and its derivatives, vinyl ethylene carbonate and its derivatives, methyl ethylene carbonate and its derivatives, lithium (bisoxalato)borate, lithium difluoro(oxalato)borate, lithium tetrafluoro(oxalato)phosphate, lithium oxalate, 2-vinylpyridine, 4-vinylpyridine, cyclic exomethylene carbonates, sultones, cyclic and acyclic sulfonates, acyclic sulfites, cyclic and acyclic sulfinates, organic esters, inorganic acids, acyclic and cyclic alkanes, said acyclic and cyclic alkanes having a boiling point at 1 bar of at least 36° C., aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocyclics.

22. The rechargeable battery cell according to claim 1, wherein the electrolyte has the composition:
(i) 5 to 99.4 wt % sulfur dioxide;
(ii) 0.6 to 95 wt % of the first conductive salt;
(iii) 0 to 25 wt % of a second conductive salt; and
(iv) 0 to 10 wt % of an additive;
relative to the total weight of the electrolyte composition.

23. The rechargeable battery cell according to claim 1, wherein the molar concentration of the first conductive salt is in a range selected from the group consisting of from 0.01 mol/l to 10 mol/l, from 0.05 mol/l to 10 mol/l, from 0.1 mol/l to 6 mol/l and from 0.2 mol/l to 3.5 mol/l relative to the total volume of the electrolyte.

24. The rechargeable battery cell according to claim 1, wherein the electrolyte contains SO₂ in an amount selected from the group consisting of at least 0.1 mole of SO₂, at least 1 mole of SO₂, at least 5 moles of SO₂, at least 10 moles of SO₂ and at least 20 moles of SO₂ per mole of conductive salt.

25. The rechargeable battery cell according to claim 1, wherein the rechargeable battery cell has a cell voltage selected from the group consisting of at least 4.0 volts, at least 4.4 volts, at least 4.8 volts, at least 5.2 volts, at least 5.6 volts and at least 6.0 volts.

26. The rechargeable battery cell according to claim 1, wherein the active metal is an alkali metal, an alkaline earth metal, or a metal from group 12 of the periodic table.

27. The rechargeable battery cell according to claim 26, wherein the active metal comprises lithium or sodium.

28. The rechargeable battery cell according to claim 26, wherein the active metal comprises calcium.

29. The rechargeable battery cell according to claim 26, wherein the active metal comprises zinc.

30. The rechargeable battery cell according to claim 1, wherein the positive electrode contains at least one compound as active material, the compound having the composition AₓM′_{y}M″_{z}Oₐ, wherein:
A is at least one metal selected from the group consisting of the alkali metals, the alkaline earth metals, the metals of group 12 of the periodic table or aluminum;
M′ is at least one metal selected from the group consisting of the elements Ti, V, Cr, Mn, Fe, Co, Ni, Cu and Zn;
M″ is at least one element selected from the group consisting of the elements of groups 2, 3, 4, 5, 6, 7, 8, 9, 10, 11, 12, 13, 14, 15 and 16 of the periodic table of elements;
x and y are independently numbers greater than 0;
z is a number greater than or equal to 0; and
a is a number greater than 0.

31. The rechargeable battery cell according to claim 30, wherein the compound has the composition LiₓNi_{y1}Mn_{y2}Co_{z}Oₐ, wherein x, y1 and y2 are independently greater than 0, z is a number greater than or equal to 0 and a is a number greater than 0.

32. The rechargeable battery cell according to claim 30, wherein the compound has the composition AₓM′_{y}M″¹_{z1}M″²_{z2}O₄, wherein M″¹ is at least one element selected from the group consisting of the elements of groups 2, 3, 4, 5, 6, 7, 8, 9, 10, 11, 12, 13, 14, 15 and 16 of the periodic table of the elements, M″² is phosphorus, z is a number greater than or equal to 0, and z2 is 1.

33. The rechargeable battery cell according to claim 1, wherein the positive electrode contains at least one metal compound selected from the group consisting of a metal oxide, a metal halide and a metal phosphate.

34. The rechargeable battery cell according to claim 33, wherein the metal compound comprises a transition metal of atomic numbers 22 to 28 of the periodic table of the elements.

35. The rechargeable battery cell according to claim 34, wherein the metal compound comprises cobalt, nickel, manganese or iron.

36. The rechargeable battery cell according to claim 1, wherein the positive electrode comprises at least one metal compound having the chemical structure of a spinel, a layered oxide, a conversion compound or a polyanionic compound.

37. The rechargeable battery cell according to claim 1, wherein the negative electrode is an insertion electrode.

38. The rechargeable battery cell according to claim 37, wherein the insertion electrode comprises carbon as the active material.

39. The rechargeable battery cell according to claim 38, wherein the carbon comprises graphite.

40. The rechargeable battery cell according to claim 1, wherein the negative electrode comprises a plurality of negative electrodes and the positive electrode comprises a plurality of positive electrodes, the negative and the positive electrodes being arranged alternately in a stack in the housing.

41. The rechargeable battery cell according to claim 40, wherein the positive and negative electrodes in the stack are electrically separated from one another by separators.
